(19) United States
(12) Patent Application Publication
(10) Pub. No.: US 2026/0256164 A1
(43) Pub. Date: Sep. 3, 2026

(54) SYSTEM FOR MAKING A FROZEN FOOD OR DRINK

(71) Applicant: IB APPLIANCES US HOLDINGS, LLC, Chicago, IL (US)

(72) Inventors: Enrique Plazarte, Fort Lauderdale, FL (US); Andrew Reed, Trumbull, CT (US); David Mathieu, Ocala, FL (US); Garrett Fink, Glastonbury, CT (US); Daniel M. Wodka, Riverside, IL (US)

(73) Assignee: IB APPLIANCES US HOLDINGS, LLC, Chicago, IL (US)

(21) Appl. No.: 19/550,619

(22) Filed: Feb. 26, 2026

Related U.S. Application Data
(60) Provisional application No. 63/804,124, filed on May 12, 2025.
(60) Provisional application No. 63/764,755, filed on Feb. 28, 2025.

(51) Int. Cl. A23G 9/08; A23G 9/22

(52) U.S. Cl. CPC A23G 9/083; A23G 9/221; A23G 9/224

(57) ABSTRACT

A system for making a frozen food or drink includes a base unit having a cooling plate and a cooling system disposed in the base unit and configured to cool the cooling plate. The cooling plate has a first horizontal dimension and a second vertical dimension, where the first horizontal dimension is greater than the second vertical dimension.

### CROSS-REFERENCE TO RELATED APPLICATIONS

This application claims priority from U.S. Provisional Application No. 63/764,755, filed February 28, 2025, and also claims priority from U.S. Provisional Application No. 63/804,124, filed May 12, 2025, which are hereby fully incorporated by reference herein in their entirety.

### TECHNICAL FIELD

The present disclosure relates generally to a system and method for making a frozen food or drink.

### BACKGROUND

Traditional devices for making frozen foods (e.g., ice cream, gelato, etc.) generally use a container that is tall and narrow, or has a similar proportion of the height to the diameter, and have most of the containers’ cooling surfaces and/or coils on the sides of the container, with little or no cooling surfaces and/or fewer cooling coils on the bottom of the container. If such containers are not fully filled, or are only partially filled, the cooling surfaces and/or coils are not fully utilized, as the contents are not fully in contact with sides of the container, which leads to slower and inefficient cooling, and longer freeze times.

Thus, an improved and more efficient frozen food system and method is needed, especially one primarily intended for “at-home” uses (as opposed to commercial-grade systems),with the functionality to make a variety of frozen foods and/or drinks (e.g., frozen cocktails, slushies, etc.)

### SUMMARY

One general aspect of the present disclosure includes a system for making a frozen food or drink, including: a base unit including a cooling plate; and a cooling system disposed in the base unit and configured to cool the cooling plate, where the cooling system includes at least one cooling coil, and where a first length of the at least one cooling coil disposed underneath the cooling plate that is proximate and/or in direct contact with the cooling plate is greater than a second length of the at least one cooling coil disposed along a sidewall of the cooling plate that is proximate and/or in direct contact with the cooling plate.

Another general aspect of the present disclosure includes a system for making a frozen food or drink, including: a base unit including a cooling plate; and a cooling system disposed in the base unit and configured to cool the cooling plate, where the cooling plate has a first horizontal dimension and a second vertical dimension, and where the first horizontal dimension is at least three times the second vertical dimension, preferably five times the second vertical dimension.

Another general aspect of the present disclosure includes a method of making a frozen food or drink including: passing a cooling liquid through at least one cooling coil disposed at least partially below a cooling plate, where a first length of the at least one cooling coil disposed underneath the cooling plate that is proximate and/or in direct contact with the cooling plate is greater than a second length of the at least one cooling coil disposed along a sidewall of the cooling plate that is proximate and/or in direct contact with the cooling plate, and where the cooling plate has a first horizontal dimension and a second vertical dimension, the first horizontal dimension being at least three times the second vertical dimension; placing at least one ingredient on a horizontal surface of the cooling plate; transferring heat from the at least one ingredient into the cooling liquid until the at least one ingredient is at least partially frozen; and removing the at least one ingredient that is at least partially frozen from the horizontal surface of the cooling plate.

Another general aspect of the present disclosure includes a system for making a frozen food or drink, including: a base unit including a cooling plate; a cooling system disposed in the base unit and configured to cool the cooling plate; a reservoir disposed on the cooling plate, where the reservoir includes a sidewall and a bottom plate, and the bottom plate is configured to hold content therein for cooling on the bottom plate via the cooling plate; and a mixing apparatus including a first arm, where the first arm is positioned to contact and scrape the bottom plate and the sidewall.

Another general aspect of the present disclosure includes a system for making a frozen food or drink, including: a base unit including a cooling plate; a cooling system disposed in the base unit and configured to cool the cooling plate; a reservoir disposed on the cooling plate, where the reservoir includes a sidewall and a bottom plate, and the bottom plate is configured to hold content therein for cooling on the bottom plate via the cooling plate; and a mixing apparatus including a first arm and a second arm, where the first arm is positioned to contact and scrape the bottom plate and the sidewall, and where the second arm is positioned to be spaced apart from the sidewall, and to contact and scrape the bottom plate.

Another general aspect of the present disclosure includes a system for making a frozen food or drink, including: a base unit including a cooling plate; a cooling system disposed in the base unit and configured to cool the cooling plate; a reservoir disposed on the cooling plate, where the reservoir includes a sidewall and a bottom plate, and the bottom plate is configured to hold content therein for cooling on the bottom plate via the cooling plate; and a mixing apparatus including a first arm, a second arm, and a third arm, where the first arm is positioned to contact and scrape the bottom plate and the sidewall, where the second arm is positioned to be spaced apart from the sidewall, and to contact and scrape the bottom plate, and where the third arm is positioned to be spaced apart from the sidewall and the bottom plate.

Another general aspect of the present disclosure includes a mixing apparatus, including a first arm, where the first arm includes a first blade extending between a first end and a second end and a first vertically extending portion disposed at the second end of the first blade, and where the first vertically extending portion extends generally perpendicular to the first blade.

Another general aspect of the present disclosure includes a system for making a frozen food or drink, including: a base unit including a cooling plate; and a cooling system disposed in the base unit and configured to cool the cooling plate, where the cooling plate has a first horizontal dimension and a second vertical dimension, and where the first horizontal dimension is greater than the second vertical dimension.

Another general aspect of the present disclosure includes a system for making a frozen food or drink, including: a base unit including a cooling plate; a cooling system disposed in the base unit and configured to cool the cooling plate; a reservoir disposed on the cooling plate, where the reservoir includes a sidewall and a bottom plate, and the bottom plate is configured to hold content therein for cooling on the bottom plate via the cooling plate; and a mixing apparatus including a first arm, where the first arm is positioned to contact and scrape the bottom plate and the sidewall.

Another general aspect of the present disclosure includes a method of making a frozen food or drink, including: passing a cooling liquid through at least one cooling coil disposed at least partially below a cooling plate, where the cooling plate has a first horizontal dimension and a second vertical dimension, the first horizontal dimension being greater than the second vertical dimension; placing at least one ingredient on a horizontal surface of the cooling plate; transferring heat from the at least one ingredient into the cooling liquid until the at least one ingredient is at least partially frozen; and removing the at least one ingredient that is at least partially frozen from the horizontal surface of the cooling plate.

A device/method according to the present disclosure may include any combination of the features described above and/or the original as-filed claims.

Other systems, methods, features and advantages of the invention will be, or will become, apparent to one with skill in the art upon examination of the following figures and detailed description. It is intended that all such additional systems, methods, features and advantages be within the scope of the invention.

### BRIEF DESCRIPTION OF DRAWINGS

FIG. 1 is an illustration of a perspective view of an embodiment of a system for making a frozen food or drink, showing a cooling plate of the system.

FIG. 2 is an illustration of a cross-sectional view of another embodiment of a system for making a frozen food or drink, showing the cooling plate and at least one cooling coil underneath the cooling plate.

FIG. 3 is an illustration showing the heat transfer from content(s) on the cooling plate to the cooling coil.

FIG. 4 is an illustration showing the making of a first frozen food on a cooling plate.

FIG. 5 is an illustration showing the making of a second frozen food on a cooling plate.

FIG. 6 is an illustration showing the making of a third frozen food using a mold on a cooling plate.

FIG. 7 is an illustration showing that the system of FIG. 1 may further include a first reservoir without a bottom plate or a second reservoir with a bottom plate.

FIG. 8 is an illustration showing a second reservoir with a bottom plate disposed on top the cooling plate of the system of FIG. 1.

FIG. 9A is an illustration showing a lid disposed on the second reservoir of FIG. 8.

FIG. 9B is an illustration showing a lid configured to be disposed along the periphery of the cooling plate of the system of FIG. 1.

FIG. 10 is an illustration showing another embodiment of a system for making a frozen food or drink, with a lower height configuration.

FIGS. 11 and 12 are illustrations showing a second reservoir with a bottom plate, a lid, and a mixing apparatus disposed above the cooling plate of the system of FIG. 1.

FIG. 13 is an illustration of an enlarged cross-sectional view of a portion of the system in FIG. 12, showing an electric motor configured for rotating the mixing apparatus.

FIG. 14 is an illustration of an embodiment of the mixing apparatus in FIGS. 11 and 12.

FIG. 15 is an illustration of a perspective view of another embodiment of the system of making a frozen food or drink, showing a reservoir disposed on a base unit of the system.

FIG. 16 is an illustration of a perspective view of a portion of the system of FIG. 15, showing certain components of the cooling system in the base unit, but excluding cooling coils, for the sake of simplicity of illustration.

FIG. 17 is an illustration of a cross-sectional view of a portion of the system of FIG. 15, showing the reservoir disposed on a cooling plate of the base unit of the system.

FIG. 18 is an illustration of a perspective view of a portion of the system of FIG. 15, showing an embodiment of a mixing apparatus disposed above a bottom plate of the reservoir.

FIG. 19 is an illustration of a cross-sectional view of a portion of the system of FIG. 15, showing the motor housing coupled to the base unit.

FIG. 20 is an illustration of another perspective view of a portion of the system of FIG. 15, showing the mixing apparatus of FIG. 18.

FIG. 21 is an illustration of another perspective view of a portion of the system of FIG. 15, showing the mixing apparatus of FIG. 18.

FIG. 22 is an illustration showing a perspective view of the mixing apparatus of FIG. 18.

FIG. 23 is an illustration showing another perspective view of the mixing apparatus of FIG. 18.

FIG. 24 is an illustration showing an exploded view of a portion of the system of FIG. 15.

FIG. 25 is an illustration showing an embodiment of the coupling mechanism between the reservoir and the base unit of the system of FIG. 15.

FIG. 26 is an illustration showing an embodiment of the cooling system in the system of FIG. 15.

FIG. 27 is an illustration showing an embodiment of the user interface of the system of FIG. 15.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments disclosed herein, such as – for example –conventional fabrication and assembly.

The invention is defined by the claims, may be embodied in many different forms, and should not be construed as limited to the embodiments set forth herein; rather, these embodiments are provided so that this disclosure will be thorough and complete, and will fully convey enabling disclosure to those skilled in the art. As used in this specification and the claims, the singular forms “a,” “an,” and “the” include plural referents unless the context clearly dictates otherwise.

The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different.

The terms “about,” “substantially,” “generally,” and other terms of degree, when used with reference to any volume, dimension, proportion, or other quantitative or qualitative value, are intended to communicate a definite and identifiable value within the standard parameters that would be understood by one of skill in the art (e.g., equivalent to a mechanical engineer with experience in this field), and should be interpreted to include at least any legal equivalents, minor but functionally-insignificant variants, standard manufacturing tolerances, and including at least mathematically significant figures(although not required to be as broad as the largest range thereof), including a variance of up to, for example 5%, 2%, 1%, or less or more as would be deemed appropriate by one of skill in the art. In addition, the term “configured to” is used to describe structural limitations in a particular manner that requires specific construction to accomplish a stated function and/or to interface or interact with another component(s), and is not used to describe mere intended or theoretical uses.

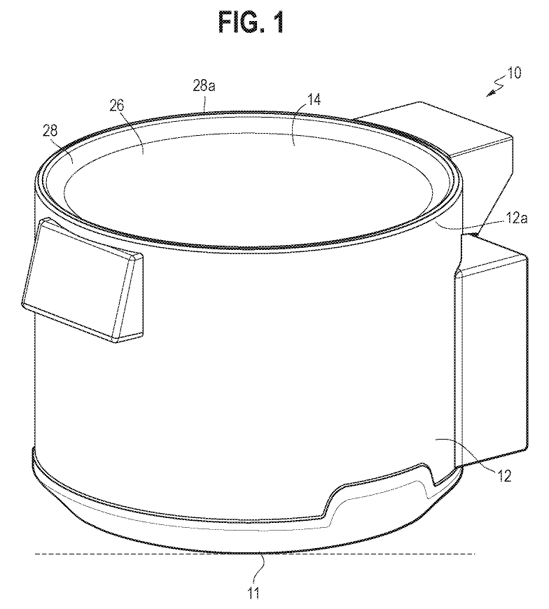

Referring to FIGS. 1-14, embodiments of a system for making a frozen food or drink are shown. In some embodiments, as shown in FIGS. 1-6, for example, the system 10 includes a base unit 12. The base unit 12 includes a cooling plate 14 disposed along an upper edge 12a of the base unit 12. As shown in FIG. 1, for example, the base unit 12 has a generally cylindrical configuration, and the upper edge 12a and the cooling plate 14 have a generally circular configuration. It will be appreciated that the shape of the base unit, the upper edge of the base unit, and the cooling plate may vary, as desired and/or needed, without departing from the present disclosure.

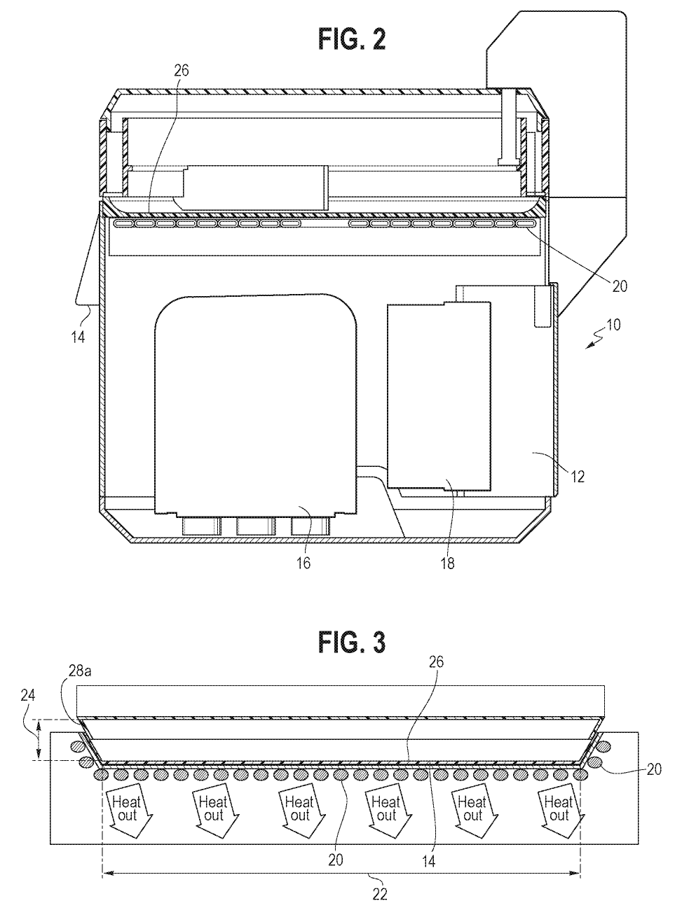

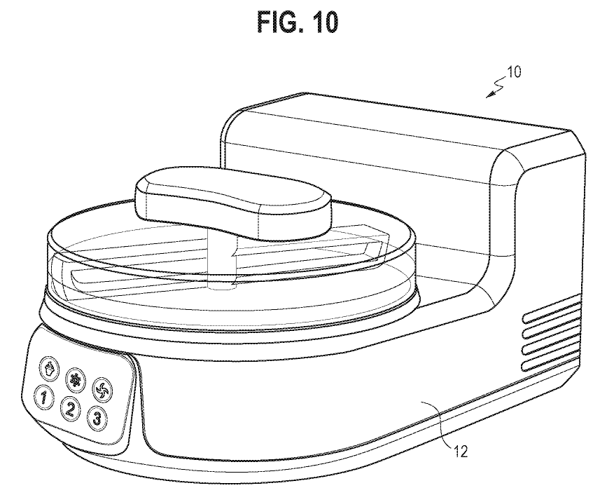

In some embodiments, the system 10 includes a cooling system disposed in the base unit 12 and configured to cool the cooling plate 14. Referring to FIGS. 2 and 3, as non-limiting examples, the cooling system may include a compressor 16, an evaporator 18, and at least one cooling coil 20, which circulates cooling liquid through the compressor 16, the evaporator 18, and the at least one cooling coil 20 to transfer heat from content(s) on the cooling plate, or in thermal communication with the cooling plate, to the cooling liquid. As shown in FIG. 2, the compressor 16 and the evaporator 18 (and/or other operative components, such as a motor) may be located below the cooling plate 14, thereby permitting the base unit 12 to have a smaller footprint, albeit a larger height. In other embodiments (for example, as shown in FIG. 10), one or both of the compressor and/or evaporator (and/or other operative components, such as a motor) may be positioned laterally adjacent to and/or above the cooling plate, so as to decrease the height of the base unit 12, albeit enlarging the footprint. Suitable cooling liquids include, for example, a refrigerant, a saline solution, and water. Other cooling systems may be utilized, as desired and/or needed, without departing from the scope of the present disclosure.

Referring to FIGS. 1-3, for example, the cooling plate 14 may have a horizontal surface 26 and a sidewall 28 extending upwards from the edge of the horizontal surface 26. As shown, the horizontal surface 26 may be generally flat and circular and the sidewall 28 may be generally curved. In some embodiments, as shown in FIG. 3, for example, the cooling plate 14 has a first horizontal dimension 22 (e.g., the diameter/width of the horizontal surface 26) and a second vertical dimension 24 (e.g., the vertical distance between an upper edge 28a of the sidewall 28 and the horizontal surface 26). “Horizontal,” “vertical,” and “upwards” are used to refer to directions relative to a surface 11 (e.g., as shown in FIG. 1) on which the base unit 12 of the system 10 is placed. In some embodiments, as shown in FGS. 1-3, for example, the first horizontal dimension 22 is greater than the second vertical dimension 24. In some embodiments, for example, the first horizontal dimension 22 is at least three times the second vertical dimension 24, preferably at least five times the second vertical dimension 24.

Referring to FIGS. 2 and 3, at least one cooling coil 20 is disposed proximate and/or in direct contact with at least a portion of the cooling plate 14 for transferring heat from the cooling plate 14 and content(s) thereon to the cooling liquid flowing through the at least one cooling coil 20. While some portion or portions of the at least one cooling coil 20 may not be proximate and/or in direct contact with the cooling plate 14 (for example, portions running to/from the compressor 16 and/or the evaporator 18), it should be appreciated that the portions proximate and/or in direct contact with the cooling plate 14 are the portions that operatively exchange heat with the cooling pate 14 and content(s) thereon. In some embodiments, the at least one cooling coil 20 has a first length disposed underneath the cooling plate 14 that is proximate and/or in direct contact with the cooling plate 14, and a second length disposed along the sidewall 28 of the cooling plate 14 that is proximate and/or in direct contact with the colling plate 14. In some embodiments, as shown in FIG. 3, for example, the first length of the at least one cooling coil 20 disposed underneath the cooling plate 14 that is proximate and/or in direct contact with the cooling plate 14 is greater than the second length of the at least one cooling coil 20 disposed along the sidewall 28 of the cooling plate 14 that is proximate and/or in direct contact with the cooling plate 14, such that most heat transfer of content(s) placed on the cooling plate is via the cooling coil(s) disposed underneath the cooling plate 14.

In some embodiments, for example, the first length of the at least one cooling coil 20 disposed underneath the cooling plate 14 that is proximate and/or in direct contact with the cooling plate 14 is at least 8 times, preferably at least 9 times the second length of the at least one cooling coil 20 disposed along the sidewall 28 of the cooling plate 14 that is proximate and/or in direct contact with the cooling plate 14. In some embodiments, as shown in FIG. 2, for example, a total length of the at least one cooling coil 20 that is proximate and/or in direct contact with the cooling plate 14 is disposed underneath the cooling plate 14. The at least one cooling coil 20 may be disposed underneath the cooling plate 14 in a circular or concentric arrangement or other arrangements (e.g., a linear array), as desired and/or needed, without departing from the scope of the present disclosure. Similarly, the at least one cooling coil may comprise a single coil, or several coils operating in parallel or series.

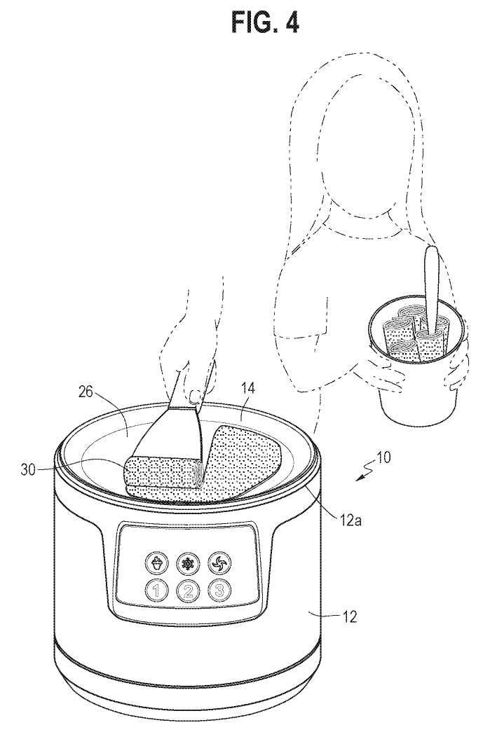

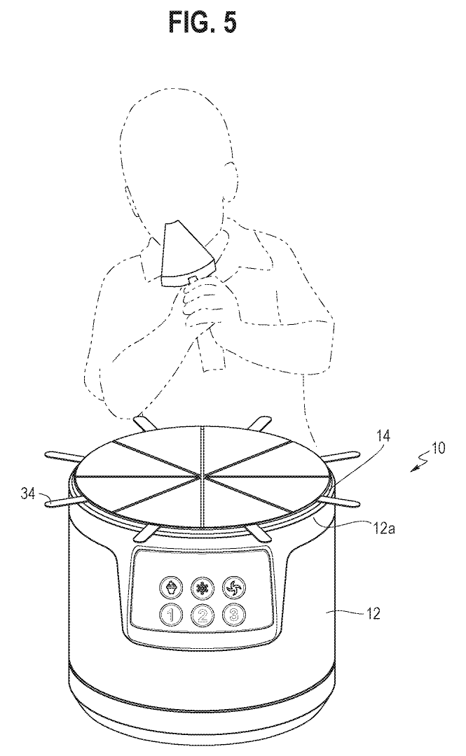

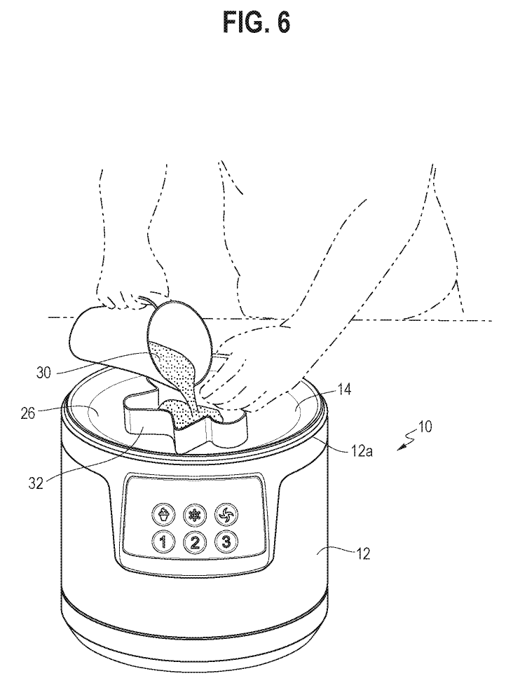

Referring to FIGS. 4-6, the cooling plate may be used to make rolled ice cream (e.g., as shown in FIG. 4), popsicles (e.g., as shown in FIG. 5, via using one or more sticks 34), and frozen shapes (e.g., as shown in FIG. 6). As shown in FIG. 4, for example, a user may place at least one ingredient 30 on the horizontal surface 26 of the cooling plate 14, and when the at least one ingredient 30 is at least partially frozen, the user may scrape it from the cooling plate 14, for example, to make rolled ice cream. As shown in FIG. 5, for example, the at least one ingredient 30 placed on the horizontal surface 26 of the cooling plate 14 may have a depth (e.g., to the extent the sidewall 28 of the cooling plate 14 allows), and a user may insert one or more sticks 34 into the ingredient 30, such that when the at least one ingredient 30 is at least partially frozen, the user may divide the ingredient that is at least partially frozen into a number of popsicles.

As shown in FIG. 6, for example, the system 10 may also include a mold 32 with a predetermined shape. The mold 32 is configured to be disposed on the horizontal surface 26 of the cooling plate 14 to define a predetermined area on the horizontal surface 26 of the cooling plate 14. In use, a user may place the mold 32 on the horizontal surface 26 of the cooling plate 14 and then place the at least one ingredient 30 in the mold 32 such that the at least one ingredient 30 is at least partially frozen according to the predetermined shape of the mold 32.

As discussed above, the cooling plate 14 has a direct cooling contact surface that can be used to make a frozen food or drink. This allows for a more direct and fast cooling process, as compared to traditional frozen food and beverage systems. The wide and shallow configuration of the cooling plate 14 (e.g., comparing to a bowl that is tall or has a similar proportion of the height to the diameter) increases the cooling contact surface area of the cooling plate with the ingredient used to make a frozen food or drink, thereby increasing cooling capacity and efficiency. The large cooling contact surface area of the cooling plate 14 also allows a user to have an easy viewpoint of and/or access to the making process of the frozen food or drink. That is, the user may easily scrape the frozen food or drink on the horizontal surface of the cooling plate and easily wipe and clean the horizontal surface of the cooling plate, without navigating utensils within, around, or over a tall vertical wall.

In some embodiments, as shown in FIG. 10, for example, the base unit 12 may be shorter in height than the embodiment shown in FIG. 1. A lower height configuration (e.g., as shown in FIG. 10) of the base unit 12 underneath the cooling plate 14 provides better access and makes it easier for shorter individuals (e.g., youths) to see the making process of the frozen food or drink (e.g., ice cream), while the taller configuration (e.g., as shown in FIG. 1) of the base unit 12 provides a smaller footprint. In this regard, the base unit 12 of FIG. 10 may position one or more of the compressor, the evaporator, and/or a motor laterally adjacent to and/or above the cooling plate 14.

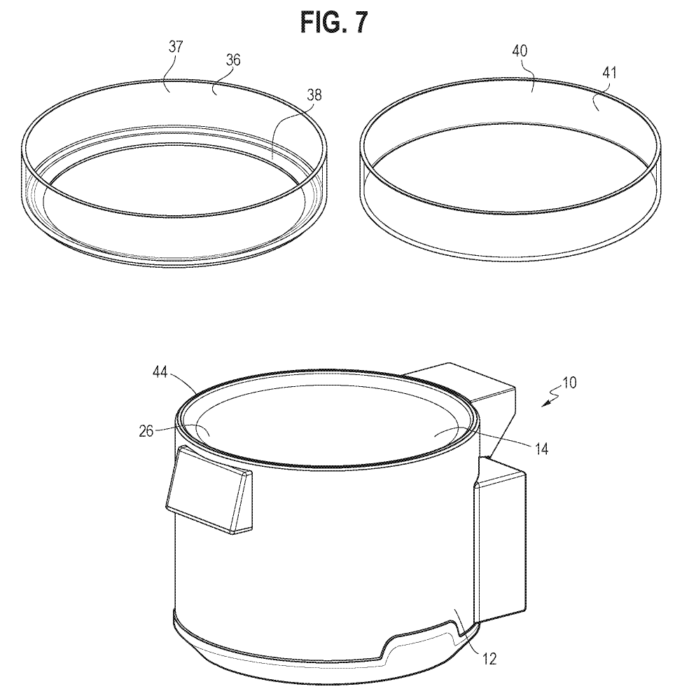

Referring to FIGS. 7-9A, the system 10 may include one or more components to extend the height of the cooling area and increase the volume of the cooling area. In some embodiments, the system 10 includes a first reservoir 40 without a bottom plate, where the first reservoir 40 is configured to be disposed above the horizontal surface 26 of the cooling plate 14, and along a periphery 44 of the cooling plate 14. For example, as shown in FIG. 7, the first reservoir 40 may have a first sidewall 41 that is generally circular and is configured to be releasably coupled to the periphery 44 of the cooling plate 14. The first sidewall 41 of the first reservoir 40 extends the height of the cooling area, such that a greater amount of frozen food or drink may be made at one time, and in direct contact with the cooling plate 14.

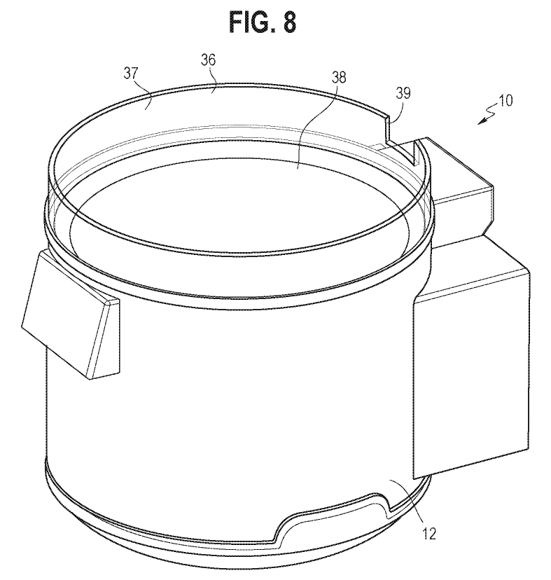

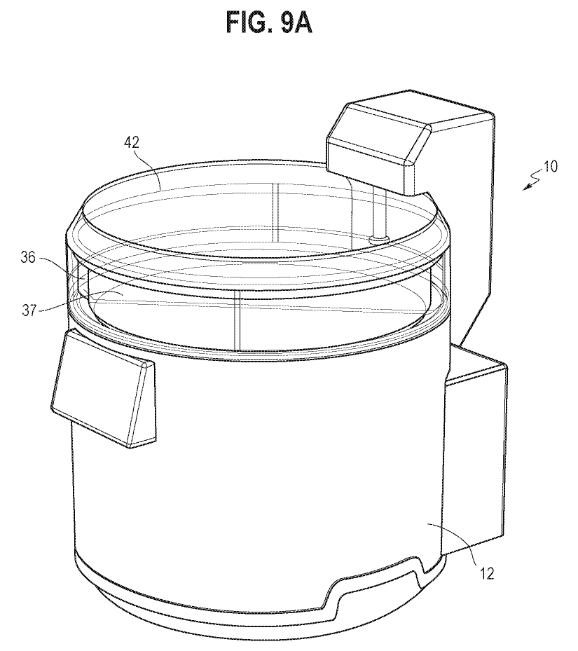

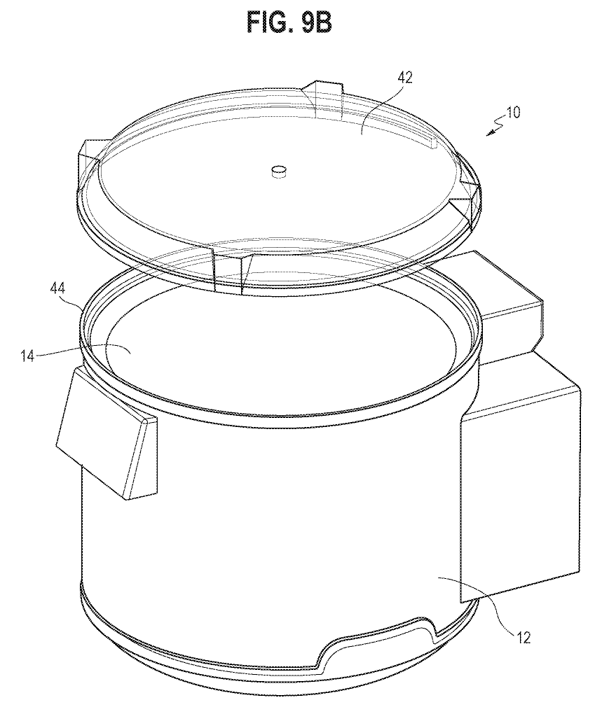

In some embodiments, the system 10 includes a second reservoir 36 with a bottom plate 38, where the bottom plate 38 is configured to hold content(s) therein for cooling on the bottom plate 38 via the cooling plate 14. For example, as shown in FIGS. 8 and 9A, the second reservoir 36 may have a second sidewall 37 that is generally circular and extends upwards from the periphery of the bottom plate 38. The second reservoir 36 is configured to be releasably coupled to the periphery 44 of the cooling plate 14. The second sidewall 37 of the second reservoir 36 extends the height of the cooling area, such that a greater amount of frozen food or drink may be made at one time. In some embodiments, as shown in FIG. 8, for example, the second sidewall 37 may include a cutout 39 configured to receive an arm extending therethrough to support a mixing apparatus. In some embodiments, the cutout 39 is also configured to provide an opening on the side of the mixing apparatus to allow for engagement between a side portion of the mixing apparatus and an output transmission (e.g., at least one gear and/or shaft) of an electric motor. It will be appreciated that the first sidewall 41 of the first reservoir 40 may also include a cutout with similar configurations and functions, as discussed above.

The second reservoir 36 also provides a separable container for receiving the ingredient and making the frozen food or drink therein, which allows the user to store the frozen food or drink in the second reservoir 36, directly take the second reservoir to serve, and/or place it directly into the freezer. In some embodiments, the bottom plate 38 may be separable from the second sidewall 37. In some embodiments, the bottom plate 38 may be constructed of stainless steel, or other materials with high thermal conductivity. In some embodiments, the bottom plate 38 may have a shape and size that matches the shape and size of the cooling plate 14, so as to maximize surface to surface contact between the bottom plate 38 and the cooling plate 14.

In some embodiments, as shown in FIG. 9A, for example, a lid 42 may be placed on the second reservoir (or the first reservoir) for faster cooling during the making process and storing the frozen food or drink after the making process. In some embodiments, as shown in FIG. 9B, for example, a lid 42 may be placed along the periphery 44 of the cooling plate 14 for faster cooling during the making process and storing the frozen food or drink after the making process.

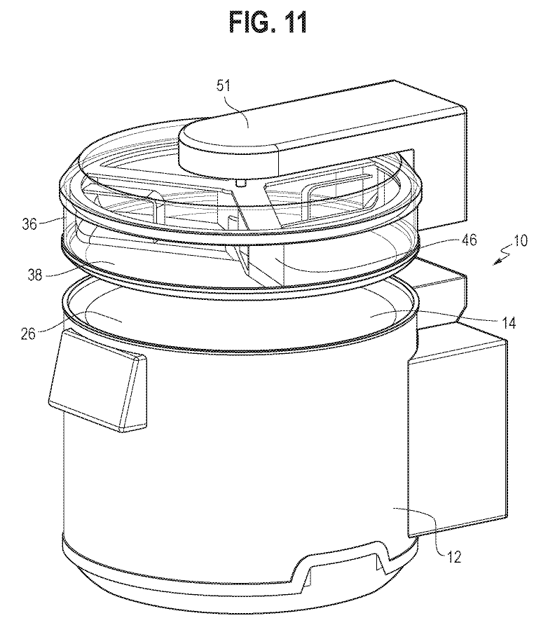

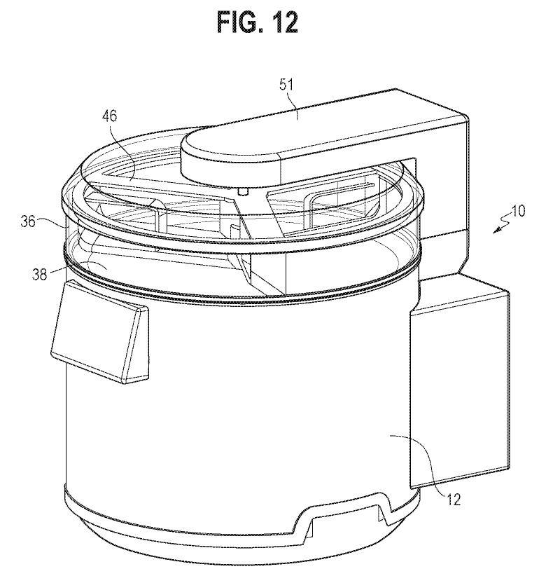

Referring to FIGS. 11-14, the system 10 may further include a mixing apparatus 46 configured to be used with or without the first reservoir 40 (i.e., without a bottom plate) or with the second reservoir 36 (i.e., with a bottom plate 38), for example, to make churned ice cream. The mixing apparatus 46 is configured to contact the horizontal surface 26 of the cooling plate 14 (e.g., when used with or without the first reservoir 40 without a bottom plate) or configured to contact the bottom plate 38 of the second reservoir 36 (e.g., when used with the second reservoir 36; as shown in FIGS. 11 and 12). The mixing apparatus 46 may be configured to scrape content(s) (e.g., ice crystals) on the cooling plate 14 or on the bottom plate 38 of the second reservoir 36, as well as stir, mix, and/or aerate content(s) on the cooling plate 14 or bottom plate 38, and/or within the first reservoir 40 or second reservoir 36. In some embodiments, referring to FIGS. 11 and 12, for example, the first or second reservoir, the mixing apparatus, and the arm 51 (discussed in greater detail below) may be configured as an individual unit that can be releasably coupled to the base unit 12 of the system and engage an electric motor in the base unit 12 to perform desired functions, as needed.

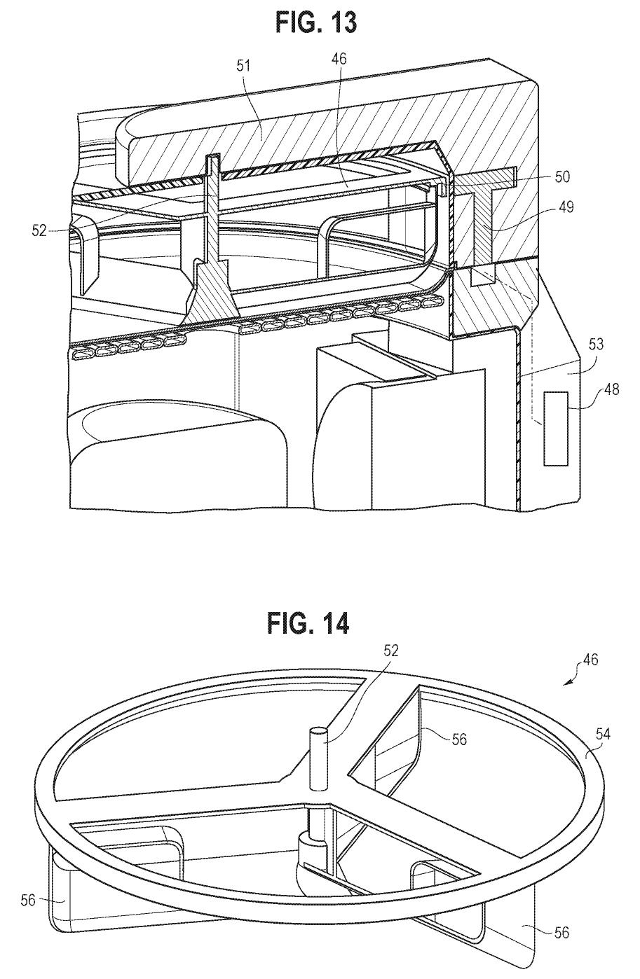

Referring to FIGS. 13 and 14, in some embodiments, the mixing apparatus 46 may include a paddle frame (e.g., a paddle ring) 54, a center portion 52 (e.g., extending along the center axis of the paddle ring 54), and at least one blade 56 (e.g., three blades as shown in FIG. 14) extending from the center portion 52 towards the periphery of the paddle ring. It will be appreciated that the configuration of the mixing apparatus 46 may be varied, as desired and/or needed, without departing from the scope of the present disclosure. For example, the number of blades may be varied to correspond with the speed of the rotation that prevents the frozen food or drink (e.g., ice cream) from turning into large crystals that do not taste or feel as creamy as smaller finer crystals.

In some embodiments, as shown in FIG. 13, for example, the system 10 also includes an electric motor 48 (schematically shown), disposed in a motor housing 53 in the base unit 12, for rotating the mixing apparatus 46. The electric motor 48 is associated with an output transmission 49, where the output transmission 49 may include at least one gear and/or shaft. The output transmission 49 is configured for transmitting a torque of the electric motor 48 to the mixing apparatus 46, where the output transmission 49 is configured to step up or step down the torque and/or speed of the electric motor 48, as desired and/needed, to obtain the desired speed/torque of the mixing apparatus 46. In some embodiments, the output transmission 49 may be configured to transmit the torque of the electric motor 48 to the mixing apparatus 46 via an engagement between the output transmission 49 and the center portion 52 of the mixing apparatus 46. In some embodiments, as shown in FIG. 13, for example, the system also includes an arm 51 (e.g., overhead arm) configured to provide a bearing about which the center portion 52 rotates, and for embodiments where the torque is applied from above the mixing apparatus (e.g., via the center portion 52), the arm 51 may house the output transmission.

In some embodiments, the output transmission 49 may be configured to transmit the torque of the electric motor 48 to the mixing apparatus 46 via an engagement between the output transmission 49 and a side portion 50 of the mixing apparatus 46. In some embodiments, the edge (e.g., perimeter circumference) of the paddle ring 54 may include gear teeth for transmitting the torque of the electric motor 48 to the mixing apparatus 46 from the side of the mixing apparatus 46. When rotating the mixing apparatus 46 from the side of the mixing apparatus 46, torque transmission is improved as compared to rotating the mixing apparatus from the center portion, which is beneficial when trying to mix thick frozen foods or drinks (e.g., ice cream). In addition, due to the greater horizontal dimension of the cooling plate 14, the forces required to rotate the mixing apparatus 46 from the center is increased, such that driving the mixing apparatus 46 from the side may avoid the increased torque requirement.

In some embodiments, the mixing apparatus 46 may be driven at a position between the center portion 52 and the side of the mixing apparatus 46 to balance the desired speed and the desired torque. In some embodiments, the mixing apparatus 46 may be driven from below, for example, through the cooling plate 14. That is, the engagement between the mixing apparatus 46 and the output transmission 49 is below the cooling plate 14. For example, the cooling plate 14 may include an opening which may be covered by a movable cap when the mixing apparatus is not in use. The opening in the cooling plate is configured to be exposed to allow for the engagement between the mixing apparatus and the output transmission disposed below the cooling plate 14.

A method of making a frozen food or drink using the system 10 is described below. In operation, the system passes a cooling liquid through the at least one cooling coil 20 disposed at least partially below the cooling plate 14. A user may place at least one ingredient 30 (directly or indirectly) on the horizontal surface 26 of the cooling plate 14. The system may transfer heat from the at least one ingredient 30 into the cooling liquid until the at least one ingredient 30 is at least partially frozen. The user may then remove the at least one ingredient 30 that is at least partially frozen from the horizontal surface 26 of the cooling plate 14.

In some embodiments, a user may also place a liner (a sheet of material, e.g., disposable wax or parchment paper) or a plate (e.g., a reuseable stainless-steel plate) between the at least one ingredient 30 and the horizontal surface 26 of the cooling plate 14 for easier cleanup, as the base unit 12 itself may not be submerged in water, or placed in a dishwasher. As discussed above, in some embodiments, a user may place a first reservoir 40 without a bottom plate above the horizontal surface 26 of the cooling plate 14, and along a periphery 44 of the cooling plate 14. With this approach, the first reservoir may be used with or without a liner or separate plate. In some embodiments, a user may place a second reservoir 36 with a bottom plate 38 above the horizontal surface 26 of the cooling plate 14 and place the at least one ingredient 30 on the bottom plate 38. Then, when the making process is completed, the user may remove the second reservoir 36 with the at least one ingredient 30 that is at least partially frozen on the bottom plate 38 from the horizontal surface 26 of the cooling plate 14.

As discussed above, the system may via a mixing apparatus 46, mix (and/or stir and/or aerate) the at least one ingredient 30 and/or scrape the at least one ingredient that is at least partially frozen from the horizontal surface 26 of the cooling plate 14. In some embodiments, the system may rotate the mixing apparatus 46 from a side of the mixing apparatus via an electric motor 48. In some embodiments, the system may rotate the mixing apparatus 46 from above the mixing apparatus (via the center portion 52) via an electric motor 48.

Traditionally a user has to pre-mix ingredients for making ice cream or other froze treats in separate bowls before pouring into a container of the frozen treat maker. This leads to more work and clean-up. In some embodiments of the present disclosure, the system 10 may include a pre-programmed setting that would allow a user to pour individual ingredients onto the cooling plate 14 and/or into the reservoirs 36, 40 without premixing. During a preliminary mixing period, the system could rotate the mixing apparatus for a predetermined time at a predetermined speed to combine and mix the unfrozen ingredients, either with or without preliminary cooling of the ingredients. Then, after the preliminary mixing period, the system would automatically adjust the cooling level and/or alter the speed of the mixing apparatus to start the process of freezing the ingredients. Additionally, when the frozen food or drink reaches a predetermined time or consistency, the system may alert the user to add in mix-ins (e.g., fruit, chocolate, candy, etc.) to help flavor the product further. At the end of the freezing process/cycle, the system may enter a “keep cool” phase to keep the frozen product at a predetermined temperature while still in the system so it doesn’t begin to melt (e.g., during serving, or prior to transfer to another vessel or cold storage).

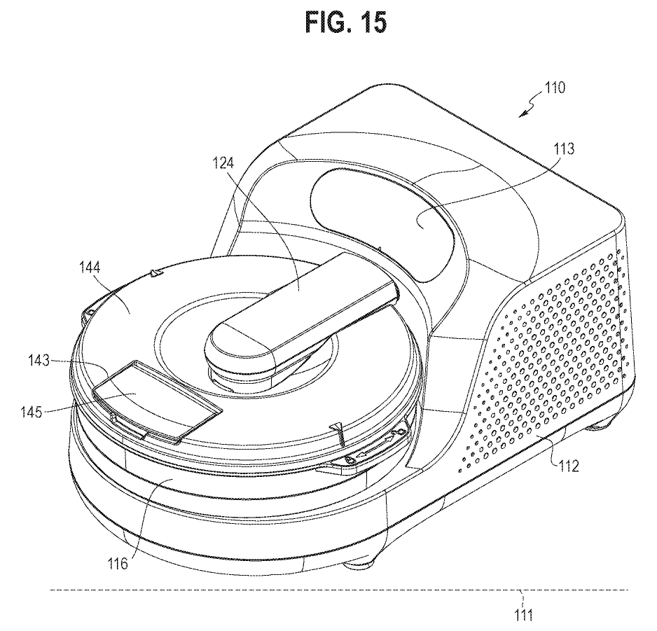

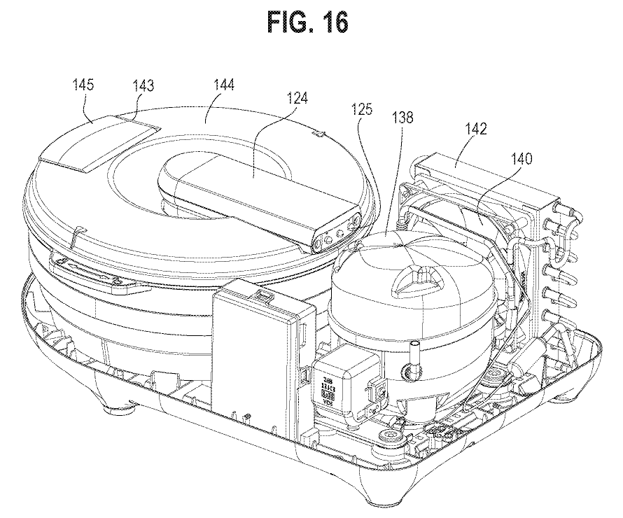

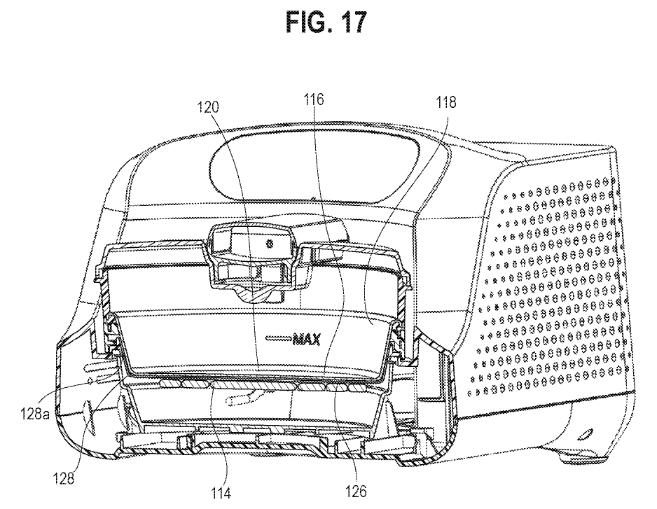

Referring to FIGS. 15-27, another embodiment of the system for making a frozen food or drink is shown. As shown in FIGS. 15-17, the system 110 includes a base unit 112 having a cooling plate 114 (e.g., as shown in FIG. 17), and a cooling system disposed in the base unit 112 and configured to cool the cooling plate 114. Referring to FIGS. 16, 24 and 26, as a non-limiting example, the cooling system may include a compressor 138, a fan 140, a condenser 142, and at least one cooling coil, which cooperate to circulate cooling liquid through the compressor 138, the condenser 142, and the at least one cooling coil (e.g., disposed at least underneath the cooling plate 114) to transfer heat from content(s) on the cooling plate 114, or in thermal communication with the cooling plate 114, to the cooling liquid. In some embodiments, the at least one cooling coil in this embodiment may have the same arrangement and proportion of cooling coils as described in relation to the embodiment described above (e.g., referring to FIGS. 2 and 3). In some embodiments, the cooling system may include a cooling liquid reservoir (not shown) for storing cooling liquid and/or a pump (not shown) for conveying the cooling liquid through the at least one cooling coil.

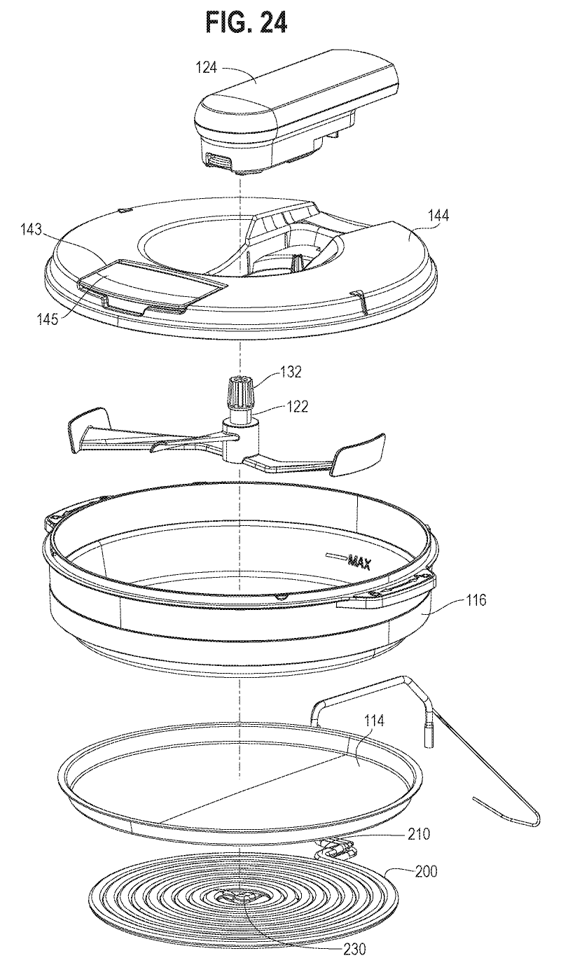

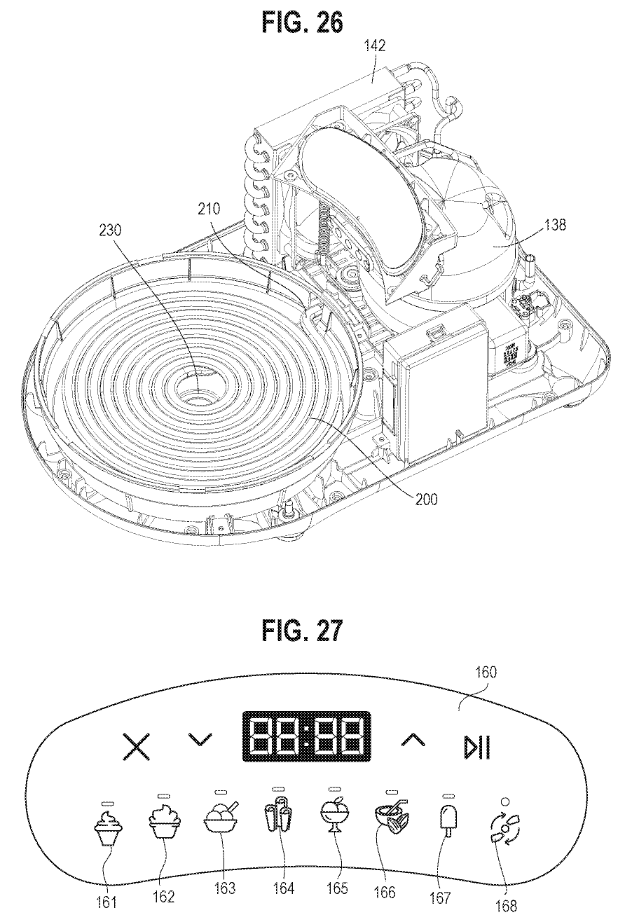

In some embodiments, as shown in FIGS. 24 and 26, the cooling system includes at least one cooling coil 200 disposed underneath the cooling plate 114, and there is no cooling coil disposed on a side of the cooling plate 114. The cooling coil 200 begins its circular path at the outer radial edge 210, extends in a spiral way to the middle portion 230. In some embodiments, the cooling coil 200 may begin its circular path at the middle portion 230 and extend in a spiral way to the outer radial edge 210. In some embodiments, two parallel cooling coils may be provided, where one cooling coil extends in a spiral way from the outer radial edge to the middle portion, and the other cooling coil extends in a spiral way from the middle portion to the outer radial edge. This configuration is advantageous for providing a more uniform cooling effect across the cooling plate. For example, during the churning process of making the ice cream, the ingredients have a tendency to be pushed outwards, and the mixing apparatus is configured to pull them back to the middle. With the uniform cooling effect provided by the parallel cooling coils discussed above, better churning effect in making the ice cream may be achieved.

As shown in FIGS. 16 and 17, the compressor 138, the fan 140, and the condenser 142 may all be positioned and housed laterally adjacent to the cooling plate 114, so as to decrease the height of the base unit 112. Suitable cooling liquids include, for example, a refrigerant, a saline solution, and water. Other cooling systems may be utilized, as desired and/or needed, without departing from the scope of the present disclosure. This embodiment is primarily intended for “at-home” uses (as opposed to commercial-grade systems), and as such, is configured in a relatively compact housing, designed for operation on a kitchen countertop, and storage in a cabinet, on a shelf, or in a kitchen pantry. However, it is envisioned that the present design and technology may be scaled for larger-scale productions and/or commercial applications.

In some embodiments, as shown in FIG. 15, the system 110 also includes a control panel 113. The control panel 113 may have one or more buttons or controls, a display screen (which could be a touch screen), and a control unit. The control unit may have a controller or processor, memory for storing software, instructions, logic, and/or firmware, which may be executed by the controller or processor to selectively control and/or program the operation of the cooling system (including, compressor, fan, condenser, and cooling liquid reservoir/pump) and the mixing motor/mixing apparatus. All of these components are in electrical communication with the controller or processor. Some programs corresponding to predetermined operations may be pre-programed, such that a user may select a desired operation via the control panel 113. In some embodiments, as shown in FIG. 15, the control panel 113 is positioned on top of the base unit 112 and is angled such that when the system 110 is placed on a countertop, the control panel 113 is facing the user for ease of use.

Referring to FIG. 17, for example, the cooling plate 114 may have a horizontal surface 126 and a sidewall 128 extending upwards from the edge of the horizontal surface 126. As shown, the horizontal surface 126 may be generally flat and circular and the sidewall 128 may be generally curved. In some embodiments, as shown in FIG. 17, for example, the cooling plate 114 has a horizontal dimension (e.g., the diameter/width of the horizontal surface 126) and a vertical dimension (e.g., the vertical distance between an upper edge 128a of the sidewall 128 and the horizontal surface 126). “Horizontal,” “vertical(ly),” and “upwards” are used to refer to directions relative to a surface 111 (e.g., as shown in FIG. 15) on which the base unit 112 of the system 110 is placed. In some embodiments, as shown in FIG. 17, for example, the horizontal dimension of the cooling plate 114 is greater than the vertical dimension of the cooling plate 114. The cooling plate 114 in this embodiment may have the same cooling plate dimensions as described in relation to the embodiment described above (e.g., referring to in FIGS. 1 and 3).

The cooling plate 114 has a direct cooling contact surface that can be used to make a frozen food or drink. The wide and shallow configuration of the cooling plate 114 (e.g., comparing to a bowl that is tall or has a similar proportion of the height to the diameter) increases the cooling contact surface area of the cooling plate with the ingredient used to make a frozen food or drink, thereby increasing cooling capacity and efficiency. That is, regardless of the volume of contents used to make the frozen food or drink, such contents will have the tendency to distribute across the cooling contact surface, maximizing thermal communication with the cooling coils in contact with or in close proximity to the cooling plate.

In some embodiments, as shown in FIGS. 15-18, for example, a reservoir 116 is disposed on the cooling plate 114, where the reservoir 116 includes a sidewall 118 and a bottom plate 120, where the sidewall 118 extends upwards from the periphery of the bottom plate 120. The bottom plate 120 is configured to hold content(s) therein for cooling on the bottom plate 120 via the cooling plate 114. In some embodiments, the bottom plate 120 may be coated to help maintain the heat transfer property of the bottom plate 120 while allowing it to be dish washer safe.

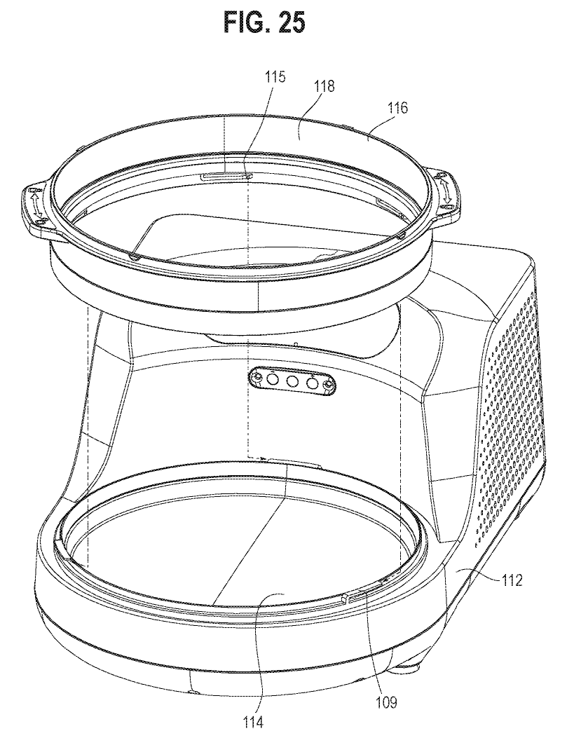

In some embodiments, the reservoir 116 is configured to be releasably coupled to the periphery of the cooling plate 114. Referring to FIG. 25, in some embodiments, the base unit 12 includes a plurality of base couplers 109 disposed at and spaced around the periphery of the cooling plate 114. The sidewall 118 of the reservoir 116 includes a plurality of reservoir couplers 115 disposed along and spaced around a circumference of the sidewall 118. One or more of the plurality of base couplers 109 and one or more of the plurality of reservoir couplers 115 are configured to be releasably coupled together by a movement of the reservoir 116 relative to the base unit 12 (e.g., rotation in a first direction) such that the reservoir 116 is secured to the base unit 12 during operation while allowing sufficient surface contact between the bottom plate 120 of the reservoir 116 and the cooling plate 114 for desired heat transfer. The reservoir 116 can also be removed from the base unit 12 (e.g., via rotation of the reservoir in a second direction relative to the base unit) for cleaning, serving, or other purposes. It will be understood that the specific configuration of the reservoir couplers and the base couplers may be varied (e.g., clamps, bayonet fitting), as desired and/or needed, without departing from the scope of the present disclosure, as long as they can releasably secure the reservoir 116 to the base unit 112 while allowing sufficient surface contact and heat transfer between the cooling plate 114 and the bottom plate 120 of the reservoir 116.

In some embodiments, the reservoir may be a single liner (e.g., aluminum liner), where the lid may include one or more lid couplers configured to couple the reservoir and the base unit together to secure the reservoir to the base unit during operation, while allowing sufficient surface contact between the bottom plate of the reservoir and the cooling plate.

In some embodiments, as shown in FIGS. 15 and 16, for example, a lid 144 may be placed on the reservoir 116 for faster cooling during the making process and storing the frozen food or drink (e.g., ice cream) after the making process. Referring to FIG. 15, the shallow and wide reservoir allows for ease of access, whether to add ingredients during the making/mixing processor, or afterwards, when using the reservoir 116 to serve the frozen treat(s). In some embodiments, the lid 144 may be transparent to provide visibility during the making process. The configuration of the system 110 with a wide reservoir, cooling from below the cooling plate (thus clear top and sides of the reservoir), and positioning the compressor, the evaporator, and/or a motor laterally adjacent to the reservoir is advantageous for allowing a user to see what is happening in the reservoir during the making process, which would make the user’s experience more enjoyable (e.g., by watching the process of freezing the ingredients). This enjoyable user experience is not possible in traditional ice cream makers with cooling coils on the sides of the reservoir.

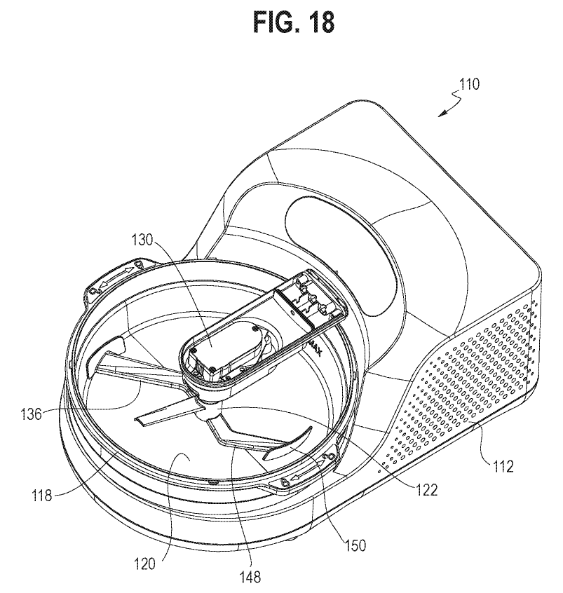

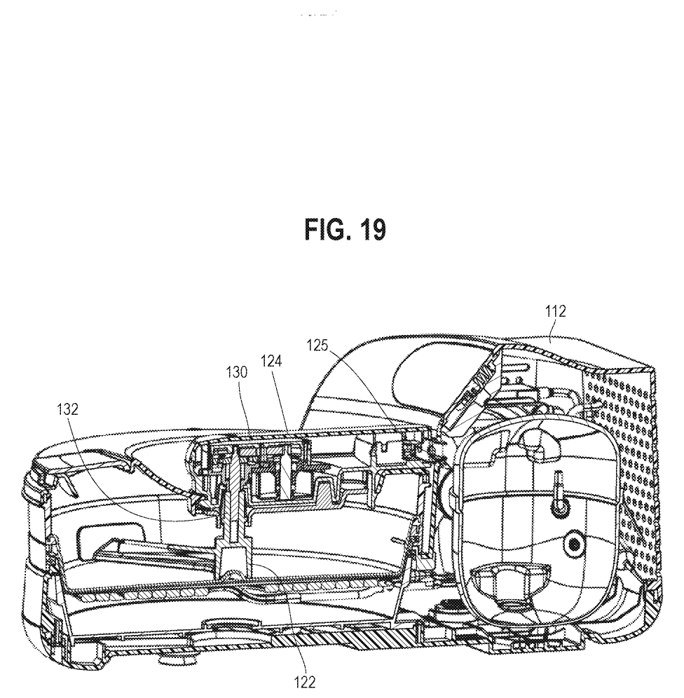

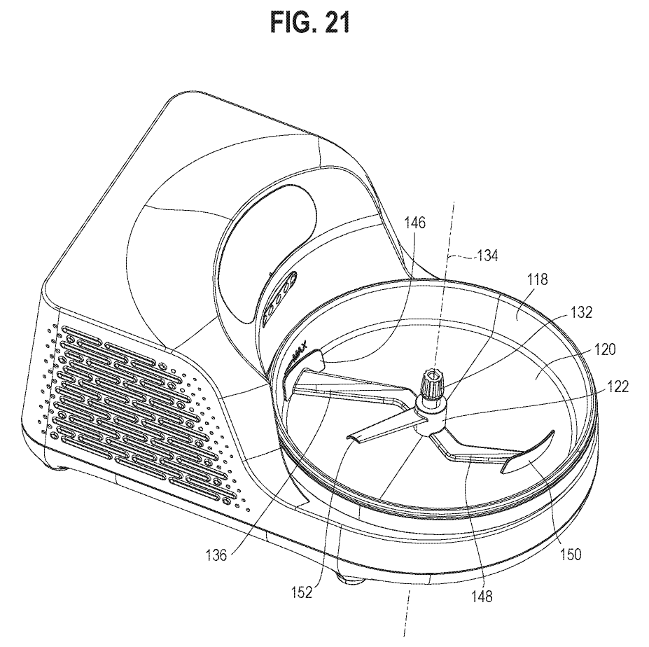

Referring to FIGS. 18 and 19, the system 110 further includes a mixing apparatus 122 configured to be used with the reservoir 116, for example, to make churned ice cream or gelato. The system 110 also includes a motor 130 configured to rotate the mixing apparatus 122 around a vertical axis 134 (e.g., as shown in FIG. 21). The mixing apparatus 122 is configured and positioned to contact the bottom plate 120 of the reservoir 116 and to scrape content(s) (e.g., ice crystals) on the bottom plate 120 of the reservoir 116, as well as stir, mix, and/or aerate content(s) on the bottom plate 120 within the reservoir 116. In some embodiments, the mixing apparatus 122 may be configured and positioned to rotate over and pass by the bottom plate 120, without contacting the bottom plate, but still mixing and/or churning the content(s) positioned on the bottom plate 120.

Referring to FIGS. 15-23, in some embodiments, the mixing apparatus 122 may include a center portion 132 (e.g., extending along the vertical axis 134 (e.g., as shown in FIG. 21) of the rotation of the mixing apparatus 122, and at least one arm (e.g., three arms) extending radially outwards from the center portion 132. As shown in FIG. 19, the motor 130 is operatively coupled to the center portion 132 so as to drive the rotation of the mixing apparatus 122. In some embodiments, as shown in FIGS. 19 and 24, the mixing apparatus 122 is configured to be releasably coupled to the motor 130 via the center portion 132, and thus releasably coupled to the lid 144, such that the mixing apparatus 122 can be removed for cleaning (e.g., in a dish washer). In some embodiments, as shown in FIGS. 15, 18 and 19, the motor 130 may be disposed in a motor housing 124 extending at least partially above the lid 144.

In some embodiments, as shown in FIGS. 16 and 19, the motor housing 124 is configured to be releasably coupled to the base unit 112 via corresponding electronic contacts 125 on the motor housing 124 and the base unit 112. In some embodiments, the reservoir 116, the mixing apparatus 122, and the motor housing 124 may be configured as an individual unit that can be releasably coupled to the base unit 112 of the system (e.g., via the corresponding electronic contacts 125, discussed above) to perform desired functions (e.g., making ice cream), as needed.

When the making process is done, the user may decouple the individual unit of the reservoir 116, the mixing apparatus 122, and the motor housing 124 from the base unit 112, separate the lid 144, the motor housing 124, and the mixing apparatus 122 from each other for further processing. For example, the user may put the lid 144 directly back on the sidewall 118 for storage of the content(s) in the reservoir 116, for example, in the kitchen freezer of a user’s home. The user may also clean the reservoir 116, the lid 144, and the mixing apparatus 122, either by hand or in a dishwasher. While the lid 144 provides safety and protection from the mixing apparatus 122, the lid 144 may also include a window or cutout to aid in addition of ingredients to the reservoir 116, either before or during mixing. In some embodiments, as shown in FIG. 15, the lid 144 includes a window 143 with a window cover 145 that can be opened or closed by a user to selectively allow or prevent access to the window 143.

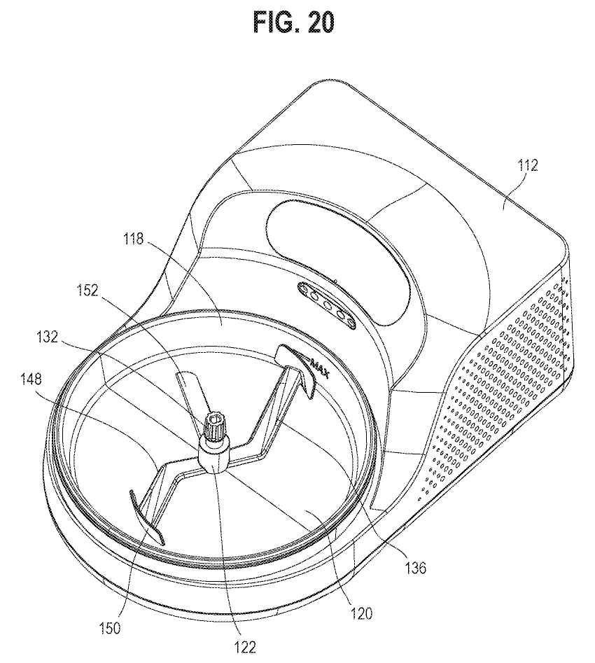

In some embodiments, as shown in FIGS. 20-23, the mixing apparatus 122 includes a first arm 136, where the first arm 136 is constructed with a length and positioned to contact and scrape both the bottom plate 120 and the sidewall 118 of the reservoir 116. The mixing apparatus 122 is configured to be rotatable around the vertical axis 134 (e.g., as shown in FIG. 21). Referring to FIGS. 21 and 23, in some embodiments, the first arm 136 has a first length 136a extending radially outward from the vertical axis 134 towards the sidewall 118 and a second length 136b extending from an end 136c of the first length 136a radially outward towards the sidewall 118. As shown, the second length 136b is angled relative to the first length 136a. In some embodiments, the second length 136b extends at a first angle α with respect to the first length 136a, where the first angle α ranges between about 110 and 150 degrees, preferably between about 120 and 140 degrees. While the first length 136a and the second length 136b are illustrated as being two independent straight lengths, it is envisioned that the first arm 136 may include more straight lengths and/or one or more curved portions extending radially outward, in one or more directions, from the vertical axis 134 to the sidewall 118.

In some embodiments, as shown in FIGS. 20-23, the first arm 136 includes a first blade that contacts and scrapes (or is positioned proximate to) the bottom plate 120 of the reservoir 116. The first blade may substantially correspond to the first length 136a, the second length 136b, the combination of the first length 136a and the second length 136b, or at least a portion of the first length 136a or the second length 136b. For example, referring to FIG. 23, when the first blade corresponds to a portion of the second length 136b, the first blade extends between a first end 136c and a second end 136e. The first arm 136 also includes a first vertically extending portion 146 disposed at the second end 136e of the first blade, or at a distal end of the first arm 136. In some embodiments, the first vertically extending portion 46 may extend generally perpendicular to the first blade and include a leading edge 146a so as to contact and scrape the sidewall 118. While the vertically extending portion 146 is illustrated as extending vertically 90 degrees relative to the first blade, it is envisioned that the vertically extending portion 146 may be contoured and/or curved according to any contour and/or curvature of the sidewall 118.

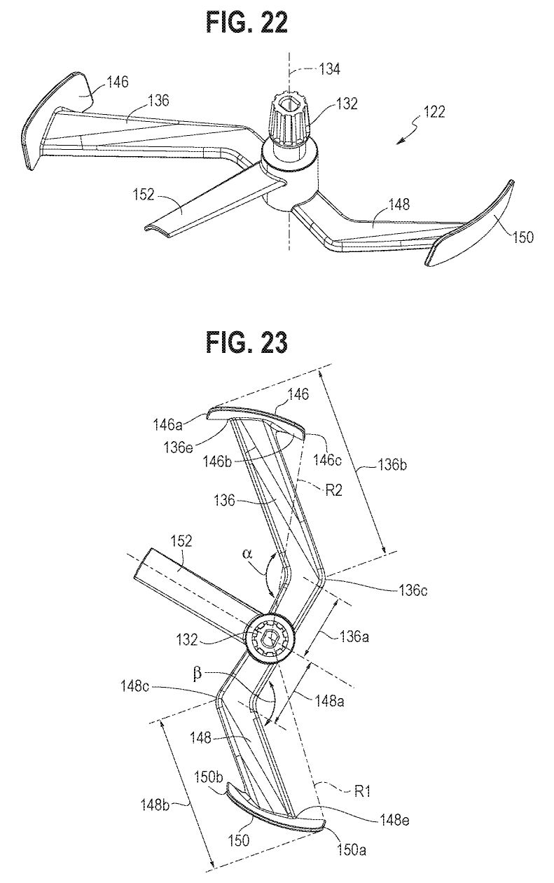

In some embodiments, as shown in FIGS. 22 and 23, for example, the first vertically extending portion 146 may include a plow or shovel 146b extending and/or curving radially inward towards the vertical axis 134, so as to deposit content(s) radially inward of the sidewall 118 and/or the leading edge 146a. Providing the first arm 136 with the first vertically extending portion 146 and plow or shovel 146b is advantageous for pulling content(s) off of the sidewall 118 (which is not as cool as the actively cooled bottom plate 120) of the reservoir 16 and towards the vertical axis 134, which facilitates keeping the content(s) in contact with the bottom plate 120 for better cooling effect. In some embodiments, these features may result in the formation of a “donut-shaped” mound of semi-frozen or frozen content(s) (e.g., ice cream) in the reservoir 116.

Referring to FIGS. 20-23, optionally, in some embodiments, the mixing apparatus 122 further includes a second arm 148, where the second arm 148 is constructed with a length and positioned to be spaced apart from the sidewall 118, and to contact and scrape the bottom plate 120 of the reservoir 116. In some embodiments, as shown in FIG. 21, the first arm 136 may be longer than the second arm 148. Referring to FIGS. 21 and 23, in some embodiments, the second arm 148 has a first length 148a extending radially outward from the vertical axis 134 towards the sidewall 118 and a second length 148b extending from an end 148c of the first length 148a radially outward towards the sidewall 118. As shown, the second length 148b is angled relative to the first length 148a. In some embodiments, the second length 148b extends at a second angle β with respect to the first length 148a, where the second angle β ranges between about 110 and 150 degrees, preferably between about 120 and 140 degrees. While the first length 148a and the second length 148b are illustrated as being two independent straight lengths, it is envisioned that the second arm 148 may include more straight lengths and/or one or more curved portions extending radially outward, in one or more directions, from the vertical axis 134 toward the sidewall 118.

In some embodiments, as shown in FIGS. 20-23, the second arm 148 includes a second blade that contacts and scrapes (or is positioned proximate to) the bottom plate 120 of the reservoir 116. The second blade may substantially correspond to the first length 148a, the second length 148b, the combination of the first length 148a and the second length 148b, or at least a portion of the first length 148a or the second length 148b. For example, referring to FIG. 23, when the second blade corresponds to a portion of the second length 148b, the second blade extends between a first end 148c and a second end 148e. The second arm 148 also includes a second vertically extending portion 150 disposed at the second end 148e of the second blade, or at a distal end of the second arm 148. In some embodiments, the second vertically extending portion 150 may extend generally perpendicular to the second blade and include a leading edge 150a. While the second vertically extending portion 150 is illustrated as extending vertically 90 degrees relative to the second blade, it is envisioned that the second vertically extending portion may be contoured and/or curved.

In some embodiments, as shown in FIGS. 22 and 23, for example, the second vertically extending portion 150 may include a plow or shovel 150b extending and/or curving radially inward towards the vertical axis 134, so as to deposit content(s) further radially inward of the second vertically extending portion 150. Providing the second arm 148 that is shorter than the first arm 136 with the second vertically extending portion 150 is advantageous, as the second vertically extending portion 150 may pull content(s) deposited from a trailing edge 146c of the first vertically extending portion 146 further towards the vertical axis 134, which facilitates keeping the content(s) in contact with the bottom plate 120 for better cooling effect. In some embodiments, the leading edge 150a of the second vertically extending portion 150 may be positioned at a radius R1 relative to the vertical axis 134 that is equal to or approximately equal to a radius R2 relative to the vertical axis 134 of the trailing edge 146c of the first vertically extending portion 146. In some embodiments, these features may further result in the formation of a “donut-shaped” mound of frozen semi-frozen content(s) (e.g., ice cream) in the reservoir 116.

Referring to FIGS. 20-23, optionally, in some embodiments, the mixing apparatus 122 further includes a third arm 152, where the third arm 152 is positioned to be spaced apart from the sidewall 118 and the bottom plate 120 of the reservoir 116. As shown in FIGS. 21 and 22, the third arm 152 extends radially outward towards the sidewall 118 and is disposed vertically offset from the first arm 136 and the second arm 148 about the vertical axis 134. The third arm 152 is positioned and configured to “flatten” and mix accumulated content scraped and pulled by the first arm 136 and/or the second arm 148. In some embodiments, the third arm 152 may be shorter than the second arm 148. Providing the third arm 152 to “flatten” the accumulated content, for example, which may be a “donut-shaped” mound of frozen or semi-frozen content, facilitates keeping the content(s) in contact with the bottom plate 120 for better cooling effect, for example, by pushing the content vertically downward toward the bottom plate 120.

It will be appreciated that the configuration of the mixing apparatus 122 may be varied, as desired and/or needed, without departing from the scope of the present disclosure. For example, the number of arms, the length of each arm, the angle α, the angle β, the relative positioning among all the arms, the configuration of the first and second vertically extending portions may be varied to correspond with the speed of the rotation of the mixing apparatus 122 to achieve the desired cooling effect, e.g., to prevent the frozen food or drink (e.g., ice cream) from turning into large crystals that do not taste or feel as creamy as smaller finer crystals.

Referring to FIG. 27, in some embodiments, the system may include a display 160 which allows a user to select different programs/functions. As shown, different functions are provided by the system, including, but not limited to, ice cream 161, airy ice cream 162, gelato 163, rolled ice cream 164, sorbet 165, non-dairy 166, popsicles 167, and mixing 168. In some embodiments, the system may have a default operating program corresponding to each selectable function to control the motor speed and operation time for different stages (e.g., mixing, churning, and/or aerating, when applicable). In some embodiments, the system may also allow a user to control the operation time and motor speed for different operating stages, change the blade type of the mixing apparatus, and/or control the cooling capacity of the cooling plate, thereby making different products (frozen yogurt, ice cream, sorbet, whipped cream Meringue, etc.) with desired characteristics.

In some embodiments, the system may not include a cooling system therein. Removal of the compressor-based cooling system may greatly reduce the overall size of the system. In some embodiments, the reservoir or the cooling plate may be configured to be inserted into a freezer for a certain amount of time and then taken out to provide cooling. In some embodiments, the bottom plate of the reservoir or the cooling plate may be provided with a cooling component (e.g., ice pad) to achieve a desired cooling effect. Then a user may use the reservoir with a mixing apparatus. In some embodiments, the mixing apparatus may be configured to be used with the reservoir within the freezer.

The subject matter of the disclosure may also relate, among others, to the following aspects:

A first aspect relates to a system for making a frozen food or drink, comprising: a base unit comprising a cooling plate; and a cooling system disposed in the base unit and configured to cool the cooling plate, wherein the cooling system comprises at least one cooling coil, and wherein a first length of the at least one cooling coil disposed underneath the cooling plate that is proximate and/or in direct contact with the cooling plate is greater than a second length of the at least one cooling coil disposed along a sidewall of the cooling plate that is proximate and/or in direct contact with the cooling plate.

A second aspect relates to the system of aspect 1, wherein the cooling plate has a first horizontal dimension and a second vertical dimension, and wherein the first horizontal dimension is greater than the second vertical dimension.

A third aspect relates to the system of any one of aspects 1 or 2, wherein the first horizontal dimension is at least three times the second vertical dimension, preferably at least five times the second vertical dimension.

A fourth aspect relates to the system of any preceding aspect, wherein the first length of the at least one cooling coil disposed underneath the cooling plate that is proximate and/or in direct contact with the cooling plate is at least 8 times, preferably at least 9 times the second length of the at least one cooling coil disposed along the sidewall of the cooling plate that is proximate and/or in direct contact with the cooling plate.

A fifth aspect relates to the system of any preceding aspect, wherein a total length of the at least one cooling coil that is proximate and/or in direct contact with the cooling plate is disposed underneath the cooling plate.

A sixth aspect relates to the system of any preceding aspect, further comprising a first reservoir without a bottom plate configured to be disposed along a periphery of the cooling plate.

A seventh aspect relates to the system of any preceding aspect, further comprising a second reservoir with a bottom plate, wherein the bottom plate is configured to hold content therein for cooling on the bottom plate via the cooling plate.

An eighth aspect relates to the system of any preceding aspect, further comprising a mixing apparatus, wherein the mixing apparatus is configured to contact a horizontal surface of the cooling plate.

A ninth aspect relates to the system of any preceding aspect, further comprising an electric motor for rotating the mixing apparatus.

A tenth aspect relates to the system of any preceding aspect, further comprising an output transmission, wherein the output transmission comprises at least one gear and/or shaft configured for transmitting a torque of the electric motor to the mixing apparatus.

An eleventh aspect relates to the system of any preceding aspect, wherein the output transmission is configured to transmit the torque of the electric motor to the mixing apparatus via an engagement between the output transmission and a center portion of the mixing apparatus.

A twelfth aspect relates to the system of any preceding aspect, wherein the output transmission is configured to transmit the torque of the electric motor to the mixing apparatus via an engagement between the output transmission and a side portion of the mixing apparatus.

A thirteenth aspect relates to the system of any preceding aspect, wherein the output transmission is configured to step up or step down the torque of the electric motor.

A fourteenth aspect relates to a system for making a frozen food or drink, comprising: a base unit comprising a cooling plate; and a cooling system disposed in the base unit and configured to cool the cooling plate, wherein the cooling plate has a first horizontal dimension and a second vertical dimension, and wherein the first horizontal dimension is at least three times the second vertical dimension, preferably five times the second vertical dimension.

A fifteenth aspect relates to the system of aspect 14, wherein the cooling system comprises at least one cooling coil, and wherein a first length of the at least one cooling coil disposed underneath the cooling plate that is proximate and/or in direct contact with the cooling plate is at least 8 times, preferably at least 9 times, a second length of the at least one cooling coil disposed along a sidewall of the cooling plate that is proximate and/or in direct contact with the cooling plate.

A sixteenth aspect relates to the system of any one of aspects 14 or 15, wherein a total length of the at least one cooling coil that is proximate and/or in direct contact with the cooling plate is disposed underneath the cooling plate.

A seventeenth aspect relates to the system of any one of aspects 14 to 16, further comprising a first reservoir without a bottom plate, wherein the first reservoir is configured to be disposed above a horizontal surface of the cooling plate, and along a periphery of the cooling plate.

An eighteenth aspect relates to the system of any one of aspects 14 to 17, further comprising a second reservoir with a bottom plate, wherein the bottom plate is configured to hold content therein for cooling on the bottom plate via the cooling plate.

A nineteenth aspect relates to the system of any one of aspects 14 to 18, further comprising a mold, wherein the mold is configured to be disposed on a horizontal surface of the cooling plate to define a predetermined area on the horizontal surface of the cooling plate.

A twentieth aspect relates to the system of any one of aspects 14 to 19, further comprising a mixing apparatus, wherein the mixing apparatus is configured to contact a horizontal surface of the cooling plate.

A twenty-first aspect relates to the system of any one of aspects 14 to 20, further comprising an electric motor for rotating the mixing apparatus.

A twenty-second aspect relates to the system of any one of aspects 14 to 21, further comprising an output transmission, wherein the output transmission comprises at least one gear and/or shaft configured for transmitting a torque of the electric motor to the mixing apparatus.

A twenty-third aspect relates to the system of any one of aspects 14 to 22, wherein the output transmission is configured to transmit the torque of the electric motor to the mixing apparatus via an engagement between the output transmission and a center portion of the mixing apparatus.

A twenty-fourth aspect relates to the system of any one of aspects 14 to 23, wherein the output transmission is configured to transmit the torque of the electric motor to the mixing apparatus via an engagement between the output transmission and a side portion of the mixing apparatus.

A twenty-fifth aspect relates to the system of any one of aspects 14 to 24, wherein the output transmission is configured to step up or step down the torque of the electric motor.

A twenty-sixth aspect relates to a method of making a frozen food or drink, comprising: passing a cooling liquid through at least one cooling coil disposed at least partially below a cooling plate, wherein a first length of the at least one cooling coil disposed underneath the cooling plate that is proximate and/or in direct contact with the cooling plate is greater than a second length of the at least one cooling coil disposed along a sidewall of the cooling plate that is proximate and/or in direct contact with the cooling plate, and wherein the cooling plate has a first horizontal dimension and a second vertical dimension, the first horizontal dimension being at least three times the second vertical dimension; placing at least one ingredient on a horizontal surface of the cooling plate; transferring heat from the at least one ingredient into the cooling liquid until the at least one ingredient is at least partially frozen; and removing the at least one ingredient that is at least partially frozen from the horizontal surface of the cooling plate.

A twenty-seventh aspect relates to the method of aspect 26, further comprising placing a liner or a plate between the at least one ingredient and the horizontal surface of the cooling plate.

A twenty-eighth aspect relates to the method of any one of aspects 26 or 27, further comprising placing a first reservoir without a bottom plate above the horizontal surface of the cooling plate, and along a periphery of the cooling plate.

A twenty-ninth aspect relates to the method of any one of aspects 26 to 28, further comprising placing a second reservoir with a bottom plate above the horizontal surface of the cooling plate and placing the at least one ingredient on the bottom plate.

A thirtieth aspect relates to the method of any one of aspects 26 to 29, further comprising removing the second reservoir with the at least one ingredient that is at least partially frozen on the bottom plate from the horizontal surface of the cooling plate.

A thirty-first aspect relates to the method of any one of aspects 26 to 30, further comprising, via a mixing apparatus, mixing the at least one ingredient and scraping the at least one ingredient that is at least partially frozen from the horizontal surface of the cooling plate.

A thirty-second aspect relates to the method of any one of aspects 26 to 31, further comprising rotating the mixing apparatus from a side of the mixing apparatus via an electric motor.

A thirty-third aspect relates to the method of any one of aspects 26 to 32, further comprising rotating the mixing apparatus from above the mixing apparatus via an electric motor.

A thirty-fourth aspect relates to the method of any one of aspects 26 to 33, further comprising placing a mold on the horizontal surface of the cooling plate, placing the at least one ingredient in the mold such that the at least one ingredient is at least partially frozen according to a predetermined shape of the mold.

A thirty-fifth aspect relates to a system for making a frozen food or drink, comprising: a base unit comprising a cooling plate; a cooling system disposed in the base unit and configured to cool the cooling plate; a reservoir disposed on the cooling plate, wherein the reservoir includes a sidewall and a bottom plate, and the bottom plate is configured to hold content therein for cooling on the bottom plate via the cooling plate; and a mixing apparatus including a first arm, wherein the first arm is positioned to contact and scrape the bottom plate and the sidewall.

A thirty-sixth aspect relates to the system of aspect 35, wherein the mixing apparatus further comprises a second arm, and wherein the first arm is longer than the second arm.

A thirty-seventh aspect relates to the system of any one of aspects 35 or 36, wherein the second arm is positioned to be spaced apart from the sidewall, and to contact and scrape the bottom plate.

A thirty-eighth aspect relates to the system of any one of aspects 35 to 37, wherein the mixing apparatus is configured to be rotatable around a vertical axis, and wherein the first arm has a first length extending radially outward from the vertical axis towards the sidewall and a second length extending from an end of the first length radially outward towards the sidewall, the second length being angled relative to the first length.

A thirty-ninth aspect relates to the system of any one of aspects 35 to 38, wherein the second arm has a first length extending radially outward from the vertical axis towards the sidewall and a second length extending from an end of the first length radially outward towards the sidewall, the second length being angled relative to the first length.

A fortieth aspect relates to the system of any one of aspects 35 to 39, wherein the mixing apparatus further comprises a third arm, and wherein the third arm is positioned to be spaced apart from the sidewall and the bottom plate.

A forty-first aspect relates to the system of any one of aspects 35 to 40, wherein the mixing apparatus is configured to be rotatable around a vertical axis, and wherein the third arm is disposed vertically offset from the first arm and the second arm about the vertical axis.

A forty-second aspect relates to the system of any one of aspects 35 to 41, wherein the first arm includes a first blade extending between a first end and a second end and a first vertically extending portion disposed at the second end of the first blade, and wherein the first vertically extending portion extends generally perpendicular to the first blade so as to contact and scrape the sidewall.

A forty-third aspect relates to the system of any one of aspects 35 to 42, wherein the mixing apparatus is configured to be rotatable around a vertical axis, and wherein the first vertically extending portion curves radially inward towards the vertical axis.

A forty-fourth aspect relates to the system of any one of aspects 35 to 43, wherein the mixing apparatus is configured to be rotatable around a vertical axis, and wherein the first vertically extending portion comprises a plow extending radially inward towards the vertical axis, so as to deposit content radially inward of the sidewall.

A forty-fifth aspect relates to a system for making a frozen food or drink, comprising: a base unit comprising a cooling plate; a cooling system disposed in the base unit and configured to cool the cooling plate; a reservoir disposed on the cooling plate, wherein the reservoir includes a sidewall and a bottom plate, and the bottom plate is configured to hold content therein for cooling on the bottom plate via the cooling plate; and a mixing apparatus including a first arm and a second arm, wherein the first arm is positioned to contact and scrape the bottom plate and the sidewall, and wherein the second arm is positioned to be spaced apart from the sidewall, and to contact and scrape the bottom plate.

A forty-sixth aspect relates to the system of aspect 45, wherein the first arm is longer than the second arm.

A forty-seventh aspect relates to the system of any one of aspects 45 or 46, wherein the mixing apparatus further comprises a third arm, and wherein the third arm is positioned to be spaced apart from the sidewall and the bottom plate.

A forty-eighth aspect relates to the system of any one of aspects 45 to 47, wherein the mixing apparatus is configured to be rotatable around a vertical axis, and wherein the third arm is disposed vertically offset from the first arm and the second arm about the vertical axis.

A forty-ninth aspect relates to the system of any one of aspects 45 to 48, wherein the mixing apparatus is configured to be rotatable around a vertical axis, and wherein the first arm has a first length extending radially outward from the vertical axis towards the sidewall and a second length extending from an end of the first length radially outward towards the sidewall, the second length being angled relative to the first length.

A fiftieth aspect relates to the system of any one of aspects 45 to 49, wherein the second arm has a first length extending radially outward from the vertical axis towards the sidewall and a second length extending from an end of the first length radially outward towards the sidewall, the second length being angled relative to the first length.

A fifty-first aspect relates to the system of any one of aspects 45 to 50, wherein the first arm includes a first blade extending between a first end and a second end and a first vertically extending portion disposed at the second end of the first blade, and wherein the first vertically extending portion extends generally perpendicular to the first blade so as to contact and scrape the sidewall.

A fifty-second aspect relates to the system of any one of aspects 45 to 51, wherein the mixing apparatus is configured to be rotatable around a vertical axis, and wherein the first vertically extending portion curves radially inward towards the vertical axis.

A fifty-third aspect relates to the system of any one of aspects 45 to 52, wherein the mixing apparatus is configured to be rotatable around a vertical axis, and wherein the first vertically extending portion comprises a plow extending radially inward towards the vertical axis, so as to deposit content radially inward of the sidewall.

A fifty-fourth aspect relates to the system of any one of aspects 45 to 53, wherein the second arm includes a second blade extending between a first end and a second end and a second vertically extending portion disposed at the second end of the second blade, and wherein the second vertically extending portion extends generally perpendicular to the second blade.

A fifty-fifth aspect relates to a system for making a frozen food or drink, comprising: a base unit comprising a cooling plate; a cooling system disposed in the base unit and configured to cool the cooling plate; a reservoir disposed on the cooling plate, wherein the reservoir includes a sidewall and a bottom plate, and the bottom plate is configured to hold content therein for cooling on the bottom plate via the cooling plate; and a mixing apparatus including a first arm, a second arm, and a third arm, wherein the first arm is positioned to contact and scrape the bottom plate and the sidewall, wherein the second arm is positioned to be spaced apart from the sidewall, and to contact and scrape the bottom plate, and wherein the third arm is positioned to be spaced apart from the sidewall and the bottom plate.

A fifty-sixth aspect relates to the system of aspect 55, wherein the first arm is longer than the second arm.

A fifty-seventh aspect relates to any one of aspects 55 or 56, wherein the mixing apparatus is configured to be rotatable around a vertical axis, and wherein the third arm is disposed vertically offset from the first arm and the second arm about the vertical axis.

A fifty-eighth aspect relates to any one of aspects 55 to 57, wherein the mixing apparatus is configured to be rotatable around a vertical axis, and wherein the first arm has a first length extending radially outward from the vertical axis towards the sidewall and a second length extending from an end of the first length radially outward towards the sidewall, the second length being angled relative to the first length.

A fifty-ninth aspect relates to any one of aspects 55 to 58, wherein the second arm has a first length extending radially outward from the vertical axis towards the sidewall and a second length extending from an end of the first length radially outward towards the sidewall, the second length being angled relative to the first length.

A sixtieth aspect relates to any one of aspects 55 to 59, wherein the first arm includes a first blade extending between a first end and a second end and a first vertically extending portion disposed at the second end of the first blade, and wherein the first vertically extending portion extends generally perpendicular to the first blade so as to contact and scrape the sidewall.

A sixty-first aspect relates to any one of aspects 55 to 60, wherein the mixing apparatus is configured to be rotatable around a vertical axis, and wherein the first vertically extending portion curves radially inward towards the vertical axis.

A sixty-second aspect relates to any one of aspects 55 to 61, wherein the mixing apparatus is configured to be rotatable around a vertical axis, and wherein the first vertically extending portion comprises a plow extending radially inward towards the vertical axis, so as to deposit content radially inward of the sidewall.

A sixty-third aspect relates to any one of aspects 55 to 62, wherein the second arm includes a second blade extending between a first end and a second end and a second vertically extending portion disposed at the second end of the second blade, and wherein the second vertically extending portion extends generally perpendicular to the second blade.

A sixty-fourth aspect relates to a mixing apparatus, comprising a first arm, wherein the first arm includes a first blade extending between a first end and a second end and a first vertically extending portion disposed at the second end of the first blade, and wherein the first vertically extending portion extends generally perpendicular to the first blade.

A sixty-fifth aspect relates to the mixing apparatus of aspect 64, wherein the mixing apparatus is configured to be rotatable around a vertical axis, and wherein the first vertically extending portion curves radially inward towards the vertical axis.

A sixty-sixth aspect relates to the mixing apparatus of any one of aspects 64 or 65, wherein the mixing apparatus is configured to be rotatable around a vertical axis, and wherein the first vertically extending portion comprises a plow extending radially inward towards the vertical axis.

A sixty-seventh aspect relates to the mixing apparatus of any one of aspects 64 to 66, further comprising a second arm, wherein the first arm is longer than the second arm.

A sixty-eighth aspect relates to the mixing apparatus of any one of aspects 64 to 67, wherein the second arm includes a second blade extending between a first end and a second end and a second vertically extending portion disposed at the second end of the second blade, and wherein the second vertically extending portion extends generally perpendicular to the second blade.

A sixty-ninth aspect relates to the mixing apparatus of any one of aspects 64 to 68, wherein the mixing apparatus is configured to be rotatable around a vertical axis, and wherein the first arm has a first length extending radially outward from the vertical axis and a second length extending radially outward from an end of the first length, the second length being angled relative to the first length.

A seventieth aspect relates to the mixing apparatus of any one of aspects 64 to 69, wherein the second arm has a first length extending radially outward from the vertical axis and a second length extending radially outward from an end of the first length, the second length being angled relative to the first length.

A seventy-first aspect relates to the mixing apparatus of any one of aspects 64 to 70, further comprising a third arm, wherein the mixing apparatus is configured to be rotatable around a vertical axis, and wherein the third arm is disposed vertically offset from the first arm and the second arm about the vertical axis.

A seventy-second aspect relates to a system for making a frozen food or drink, comprising: a base unit comprising a cooling plate; and a cooling system disposed in the base unit and configured to cool the cooling plate, wherein the cooling plate has a first horizontal dimension and a second vertical dimension, and wherein the first horizontal dimension is greater than the second vertical dimension.

A seventy-third aspect relates to the system of aspect 72, wherein the first horizontal dimension is at least three times the second vertical dimension, preferably five times the second vertical dimension.

A seventy-fourth aspect relates to the system of any one of aspects 72 or 73, wherein the cooling system comprises at least one cooling coil, and wherein a total length of the at least one cooling coil that is proximate and/or in direct contact with the cooling plate is disposed underneath the cooling plate.

A seventy-fifth aspect relates to the system of any one of aspects 72 to 74, further comprising a first reservoir without a bottom plate, wherein the first reservoir is configured to be disposed above a horizontal surface of the cooling plate, and along a periphery of the cooling plate.

A seventy-sixth aspect relates to the system of any one of aspects 72 to 75, further comprising a second reservoir with a bottom plate, wherein the bottom plate is configured to hold content therein for cooling on the bottom plate via the cooling plate.

A seventy-seventh aspect relates to the system of any one of aspects 72 to 76, further comprising a mold, wherein the mold is configured to be disposed on a horizontal surface of the cooling plate to define a predetermined area on the horizontal surface of the cooling plate.

A seventy-eighth aspect relates to a system for making a frozen food or drink, comprising: a base unit comprising a cooling plate; a cooling system disposed in the base unit and configured to cool the cooling plate; a reservoir disposed on the cooling plate, wherein the reservoir includes a sidewall and a bottom plate, and the bottom plate is configured to hold content therein for cooling on the bottom plate via the cooling plate; and a mixing apparatus including a first arm, wherein the first arm is positioned to contact and scrape the bottom plate and the sidewall.

A seventy-ninth aspect relates to the system of aspect 78, wherein the cooling system comprises at least one cooling coil disposed underneath the cooling plate, and wherein there is no cooling coil disposed on a side of the cooling plate.

An eightieth aspect relates to the system of any one of aspects 78 or 79, wherein the mixing apparatus further comprises a second arm, and wherein the first arm is longer than the second arm.

An eighty-first aspect relates to the system of any one of aspects 78 to 80, wherein the second arm is positioned to be spaced apart from the sidewall, and to contact and scrape the bottom plate.

An eighty-second aspect relates to the system of any one of aspects 78 to 81, wherein the mixing apparatus is configured to be rotatable around a vertical axis, wherein the second arm has a first length extending radially outward from the vertical axis towards the sidewall and a second length extending from an end of the first length radially outward towards the sidewall, the second length being angled relative to the first length.

An eighty-third aspect relates to the system of any one of aspects 78 to 82, wherein the mixing apparatus is configured to be rotatable around a vertical axis, and wherein the first arm has a first length extending radially outward from the vertical axis towards the sidewall and a second length extending from an end of the first length radially outward towards the sidewall, the second length being angled relative to the first length.

An eighty-fourth aspect relates to the system of any one of aspects 78 to 83, wherein the mixing apparatus further comprises a third arm, and wherein the third arm is positioned to be spaced apart from the sidewall and the bottom plate.

An eighty-fifth aspect relates to the system of any one of aspects 78 to 84, wherein the first arm includes a first blade extending between a first end and a second end and a first vertically extending portion disposed at the second end of the first blade, and wherein the first vertically extending portion extends generally perpendicular to the first blade so as to contact and scrape the sidewall.

An eighty-sixth aspect relates to a method of making a frozen food or drink comprising: passing a cooling liquid through at least one cooling coil disposed at least partially below a cooling plate, wherein the cooling plate has a first horizontal dimension and a second vertical dimension, the first horizontal dimension being greater than the second vertical dimension; placing at least one ingredient on a horizontal surface of the cooling plate; transferring heat from the at least one ingredient into the cooling liquid until the at least one ingredient is at least partially frozen; and removing the at least one ingredient that is at least partially frozen from the horizontal surface of the cooling plate.

An eighty-seventh aspect relates to the method of aspect 86, further comprising, via a mixing apparatus, mixing the at least one ingredient and scraping the at least one ingredient that is at least partially frozen from the horizontal surface of the cooling plate.

An eighty-eighth aspect relates to the method of any one of aspects 86 or 87, further comprising placing a liner or a plate between the at least one ingredient and the horizontal surface of the cooling plate.

An eighty-ninth aspect relates to the method of any one of aspects 86 to 88, further comprising placing a first reservoir without a bottom plate above the horizontal surface of the cooling plate, and along a periphery of the cooling plate.

A ninetieth aspect relates to the method of any one of aspects 86 to 89, further comprising placing a second reservoir with a bottom plate above the horizontal surface of the cooling plate and placing the at least one ingredient on the bottom plate.

A ninety-first aspect relates to the method of any one of aspects 86 to 90, further comprising removing the second reservoir with the at least one ingredient that is at least partially frozen on the bottom plate from the horizontal surface of the cooling plate.

Those of skill in the art will appreciate that embodiments not expressly illustrated herein may be practiced within the scope of the claims, including that features described herein for different embodiments may be combined with each other and/or with currently-known or future-developed technologies while remaining within the scope of the claims. Although specific terms are employed herein, they are used in a generic and descriptive sense only and not for purposes of limitation unless specifically defined by context, usage, or other explicit designation. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the invention, and it is not necessarily expected that all of the described advantages will be achieved with every embodiment. In the event of any inconsistent disclosure or definition from the present application conflicting with any document incorporated by reference, the disclosure or definition herein shall be deemed to prevail.

We claim:

1. A system for making a frozen food or drink, comprising:
a base unit comprising a cooling plate; and
a cooling system disposed in the base unit and configured to cool the cooling plate,
wherein the cooling plate has a first horizontal dimension and a second vertical dimension, and wherein the first horizontal dimension is greater than the second vertical dimension.

2. The system of claim 1, wherein the first horizontal dimension is at least three times the second vertical dimension, preferably five times the second vertical dimension.

3. The system of claim 1, wherein the cooling system comprises at least one cooling coil, and wherein a total length of the at least one cooling coil that is proximate and/or in direct contact with the cooling plate is disposed underneath the cooling plate.

4. The system of claim 1, further comprising a first reservoir without a bottom plate, wherein the first reservoir is configured to be disposed above a horizontal surface of the cooling plate, and along a periphery of the cooling plate.

5. The system of claim 1, further comprising a second reservoir with a bottom plate, wherein the bottom plate is configured to hold content therein for cooling on the bottom plate via the cooling plate.

6. The system of claim 1, further comprising a mold, wherein the mold is configured to be disposed on a horizontal surface of the cooling plate to define a predetermined area on the horizontal surface of the cooling plate.

7. A system for making a frozen food or drink, comprising:
a base unit comprising a cooling plate;
a cooling system disposed in the base unit and configured to cool the cooling plate;
a reservoir disposed on the cooling plate, wherein the reservoir includes a sidewall and a bottom plate, and the bottom plate is configured to hold content therein for cooling on the bottom plate via the cooling plate; and
a mixing apparatus including a first arm, wherein the first arm is positioned to contact and scrape the bottom plate and the sidewall.

8. The system of claim 7, wherein the cooling system comprises at least one cooling coil disposed underneath the cooling plate, and wherein there is no cooling coil disposed on a side of the cooling plate.

9. The system of claim 7, wherein the mixing apparatus further comprises a second arm, and wherein the first arm is longer than the second arm.

10. The system of claim 9, wherein the second arm is positioned to be spaced apart from the sidewall, and to contact and scrape the bottom plate.

11. The system of claim 9, wherein the mixing apparatus is configured to be rotatable around a vertical axis, wherein the second arm has a first length extending radially outward from the vertical axis towards the sidewall and a second length extending from an end of the first length radially outward towards the sidewall, the second length being angled relative to the first length.

12. The system of claim 7, wherein the mixing apparatus is configured to be rotatable around a vertical axis, and wherein the first arm has a first length extending radially outward from the vertical axis towards the sidewall and a second length extending from an end of the first length radially outward towards the sidewall, the second length being angled relative to the first length.

13. The system of claim 7, wherein the mixing apparatus further comprises a third arm, and wherein the third arm is positioned to be spaced apart from the sidewall and the bottom plate.

14. The system of claim 7, wherein the first arm includes a first blade extending between a first end and a second end and a first vertically extending portion disposed at the second end of the first blade, and wherein the first vertically extending portion extends generally perpendicular to the first blade so as to contact and scrape the sidewall.

15. A method of making a frozen food or drink, comprising:
passing a cooling liquid through at least one cooling coil disposed at least partially below a cooling plate, wherein the cooling plate has a first horizontal dimension and a second vertical dimension, the first horizontal dimension being greater than the second vertical dimension;
placing at least one ingredient on a horizontal surface of the cooling plate;
transferring heat from the at least one ingredient into the cooling liquid until the at least one ingredient is at least partially frozen; and
removing the at least one ingredient that is at least partially frozen from the horizontal surface of the cooling plate.

16. The method of claim 15, further comprising, via a mixing apparatus, mixing the at least one ingredient and scraping the at least one ingredient that is at least partially frozen from the horizontal surface of the cooling plate.

17. The method of claim 15, further comprising placing a liner or a plate between the at least one ingredient and the horizontal surface of the cooling plate.

18. The method of claim 15, further comprising placing a first reservoir without a bottom plate above the horizontal surface of the cooling plate, and along a periphery of the cooling plate.

19. The method of claim 15, further comprising placing a second reservoir with a bottom plate above the horizontal surface of the cooling plate and placing the at least one ingredient on the bottom plate.

20. The method of claim 19, further comprising removing the second reservoir with the at least one ingredient that is at least partially frozen on the bottom plate from the horizontal surface of the cooling plate.
